(19) United States
(12) Patent Application Publication
(10) Pub. No.: US 2026/0270973 A1
(43) Pub. Date: Sep. 10, 2026

(54) NETWORK NODE BASED BEAM PREDICTION FOR CELL GROUP SETUP

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/994,859

(22) PCT Filed: Sep. 16, 2022
(86) PCT No.: PCT/CN2022/119239

§ 371 Date: Jan. 15, 2025

(51) Int. Cl. H04W 72/044; H04W 72/542; H04W 74/0833

(52) U.S. Cl. CPC H04W 72/046; H04W 72/542; H04W 74/0833

(57) ABSTRACT

Various aspects of the present disclosure generally relate to wireless communication. In some aspects, a user equipment (UE) may transmit, to a first serving cell, one or more channel measurements associated with one or more beams received from the first serving cell. The UE may receive, from the first serving cell, an indication of one or more candidate beams associated with a second serving cell based at least in part on the one or more channel measurements associated with the one or more beams received from the first serving cell. The UE may transmit, to the second serving cell, a random access channel (RACH) uplink communication based at least in part on the indication of the one or more candidate beams associated with the second serving cell. Numerous other aspects are described.

### FIELD OF THE DISCLOSURE

Aspects of the present disclosure generally relate to wireless communication and to techniques and apparatuses for network node based beam prediction for cell group setup (e.g., for secondary cell group (SCG) setup).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include transmitting, to a first serving cell, one or more channel measurements associated with one or more beams received from the first serving cell. The method may include receiving, from the first serving cell, an indication of one or more candidate beams associated with a second serving cell based at least in part on the one or more channel measurements associated with the one or more beams received from the first serving cell. The method may include transmitting, to the second serving cell, a random access channel (RACH) uplink communication based at least in part on the indication of the one or more candidate beams associated with the second serving cell.

Some aspects described herein relate to a method of wireless communication performed by an apparatus of a network node associated with a first serving cell. The method may include receiving, from a UE, one or more channel measurements for one or more beams associated with the first serving cell. The method may include determining, based at least in part on the one or more channel measurements, one or more candidate beams associated with a second serving cell. The method may include transmitting, to the UE, an indication of the one or more candidate beams associated with the second serving cell.

Some aspects described herein relate to a UE for wireless communication. The UE may include a memory and one or more processors coupled to the memory. The one or more processors may be configured to transmit, to a first serving cell, one or more channel measurements associated with one or more beams received from the first serving cell. The one or more processors may be configured to receive, from the first serving cell, an indication of one or more candidate beams associated with a second serving cell based at least in part on the one or more channel measurements associated with the one or more beams received from the first serving cell. The one or more processors may be configured to transmit, to the second serving cell, a RACH uplink communication based at least in part on the indication of the one or more candidate beams associated with the second serving cell.

Some aspects described herein relate to a network node for wireless communication. The network node may be associated with a first serving cell. The network node may include a memory and one or more processors coupled to the memory. The one or more processors may be configured to receive, from a UE, one or more channel measurements for one or more beams associated with the first serving cell. The one or more processors may be configured to determine, based at least in part on the one or more channel measurements, one or more candidate beams associated with a second serving cell. The one or more processors may be configured to transmit, to the UE, an indication of the one or more candidate beams associated with the second serving cell.

Some aspects described herein relate to a non-transitory computer-readable medium that stores a set of instructions for wireless communication by a UE. The set of instructions, when executed by one or more processors of the UE, may cause the UE to transmit, to a first serving cell, one or more channel measurements associated with one or more beams received from the first serving cell. The set of instructions, when executed by one or more processors of the UE, may cause the UE to receive, from the first serving cell, an indication of one or more candidate beams associated with a second serving cell based at least in part on the one or more channel measurements associated with the one or more beams received from the first serving cell. The set of instructions, when executed by one or more processors of the UE, may cause the UE to transmit, to the second serving cell, a RACH uplink communication based at least in part on the indication of the one or more candidate beams associated with the second serving cell.

Some aspects described herein relate to a non-transitory computer-readable medium that stores a set of instructions for wireless communication by a network node associated with a first serving cell. The set of instructions, when executed by one or more processors of the network node, may cause the network node to receive, from a UE, one or more channel measurements for one or more beams associated with the first serving cell. The set of instructions, when executed by one or more processors of the network node, may cause the network node to determine, based at least in part on the one or more channel measurements, one or more candidate beams associated with a second serving cell. The set of instructions, when executed by one or more processors of the network node, may cause the network node to transmit, to the UE, an indication of the one or more candidate beams associated with the second serving cell.

Some aspects described herein relate to an apparatus for wireless communication. The apparatus may include means for transmitting, to a first serving cell, one or more channel measurements associated with one or more beams received from the first serving cell. The apparatus may include means for receiving, from the first serving cell, an indication of one or more candidate beams associated with a second serving cell based at least in part on the one or more channel measurements associated with the one or more beams received from the first serving cell. The apparatus may include means for transmitting, to the second serving cell, a RACH uplink communication based at least in part on the indication of the one or more candidate beams associated with the second serving cell.

Some aspects described herein relate to an apparatus for wireless communication. The apparatus may include means for receiving, from a UE, one or more channel measurements for one or more beams associated with a first serving cell. The apparatus may include means for determining, based at least in part on the one or more channel measurements, one or more candidate beams associated with a second serving cell. The apparatus may include means for transmitting, to the UE, an indication of the one or more candidate beams associated with the second serving cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of an artificial intelligence/machine learning based beam management, in accordance with the present disclosure.

FIGS. 7A-7C and 8-10 are diagrams illustrating examples associated with network node based beam prediction for secondary cell group setup, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

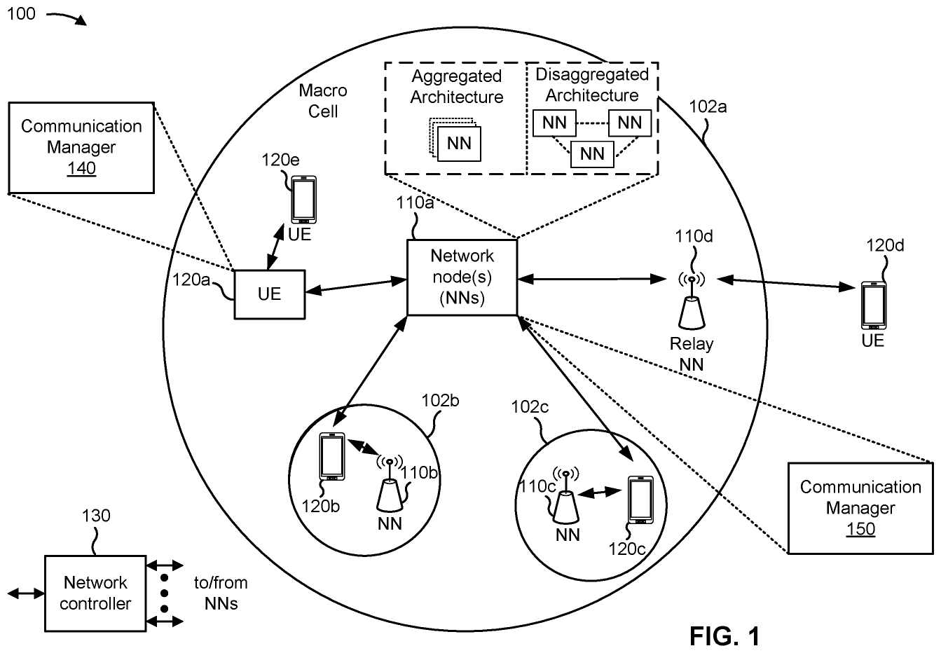

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a radio access network (RAN) node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a first serving cell, one or more channel measurements associated with one or more beams received from the first serving cell; receive, from the first serving cell, an indication of one or more candidate beams associated with a second serving cell based at least in part on the one or more channel measurements associated with the one or more beams received from the first serving cell; and transmit, to the second serving cell, a random access channel (RACH) uplink communication based at least in part on the indication of the one or more candidate beams associated with the second serving cell. Additionally, or alternatively, the communication manager 140 may perform one or more other operations described herein.

In some aspects, the network node 110 may include a communication manager 150. As described in more detail elsewhere herein, the communication manager 150 may receive, from a UE, one or more channel measurements for one or more beams associated with a first serving cell; determine, based at least in part on the one or more channel measurements, one or more candidate beams associated with a second serving cell; and transmit, to the UE, an indication of the one or more candidate beams associated with the second serving cell. Additionally, or alternatively, the communication manager 150 may perform one or more other operations described herein.

As indicated above, FIG. 1 is provided as an example. Other examples may differ from what is described with regard to FIG. 1.

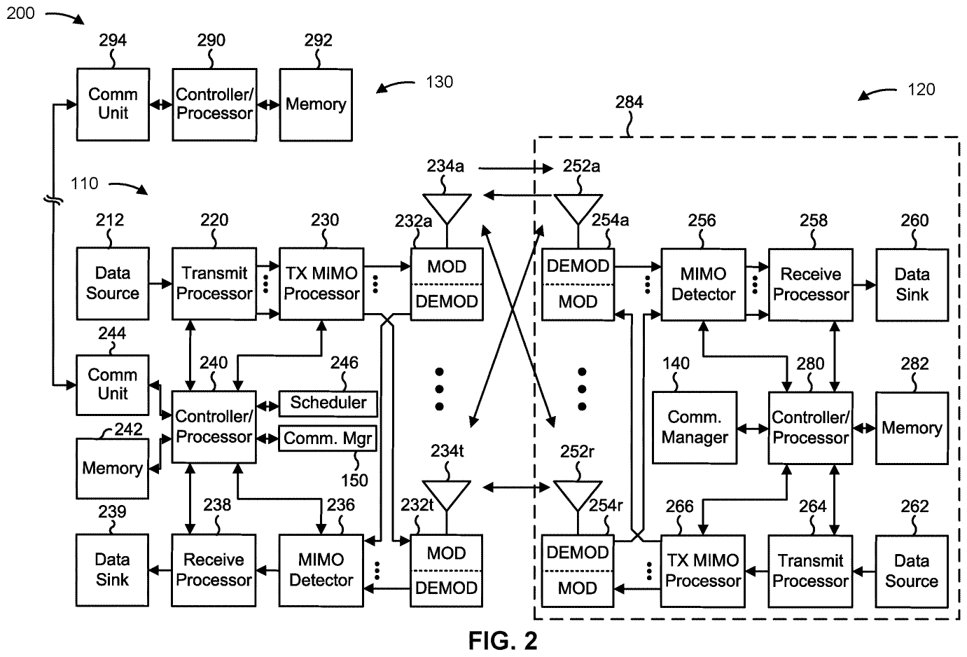

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

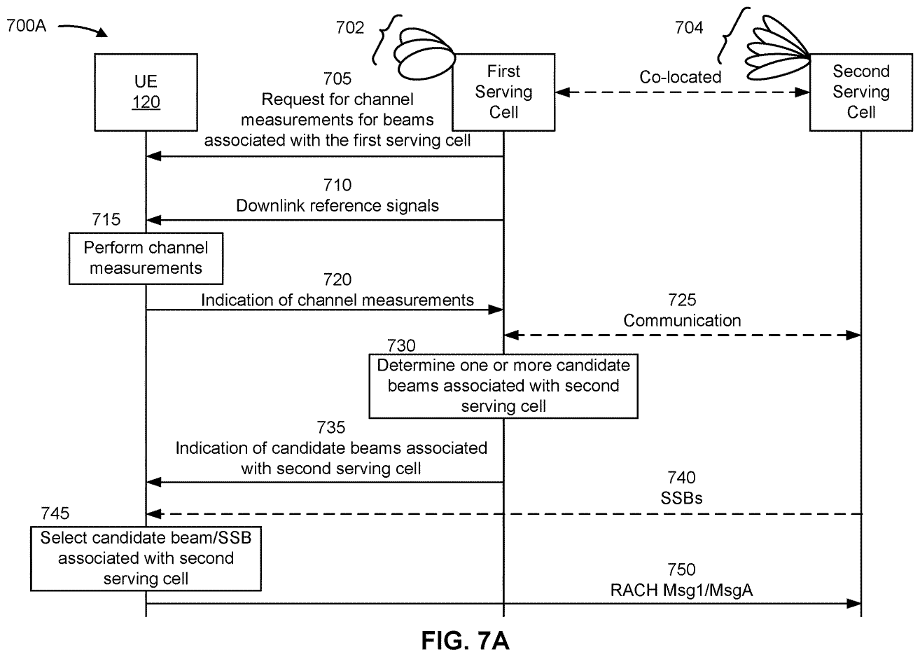

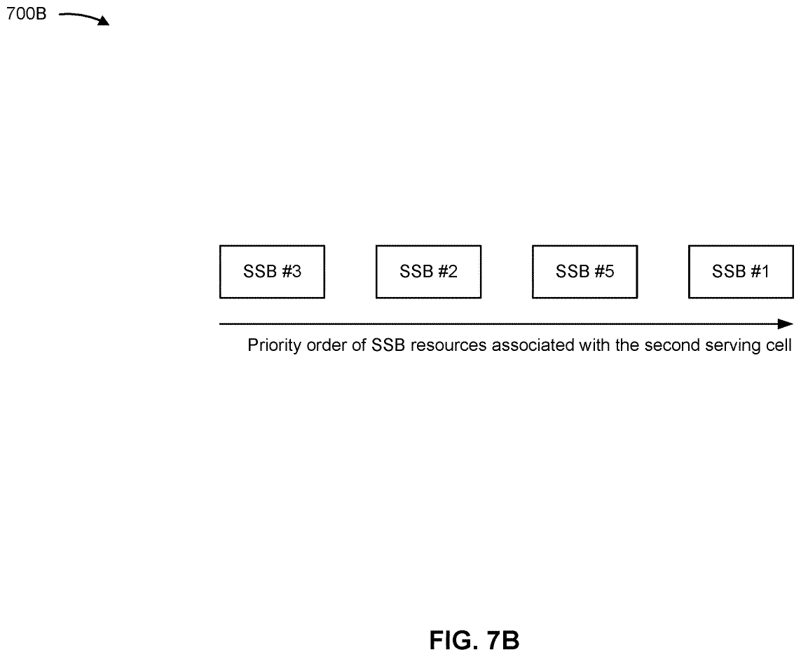

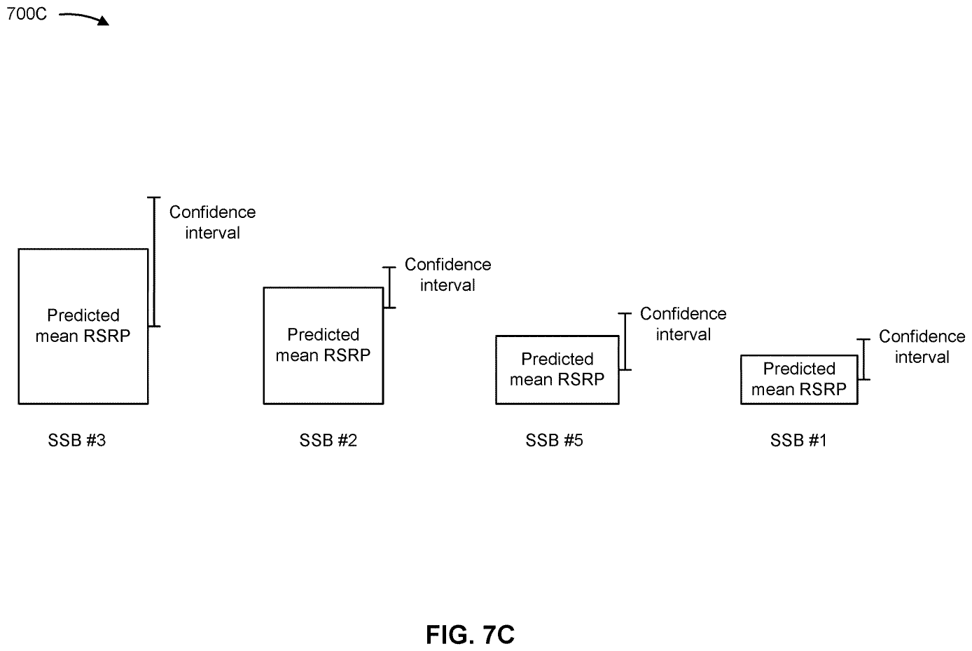

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7C and 8-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7C and 8-14).

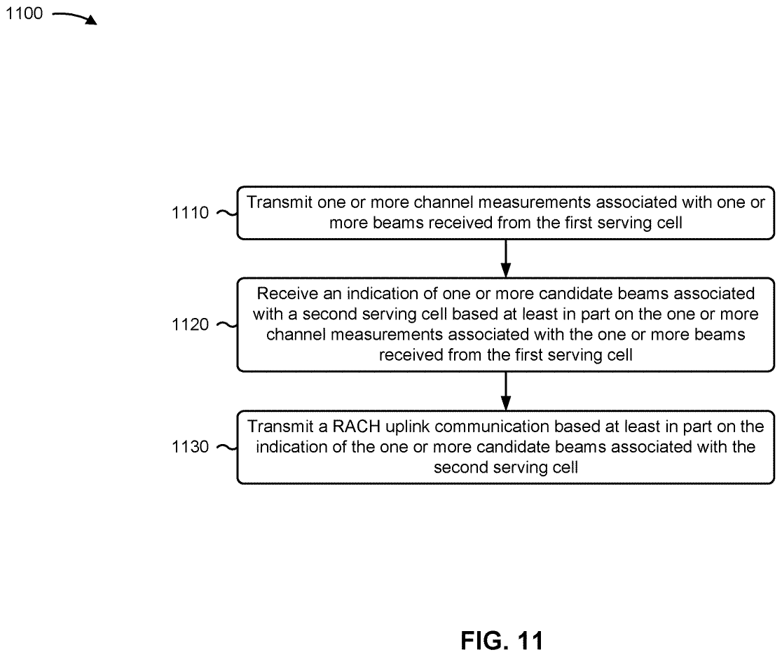

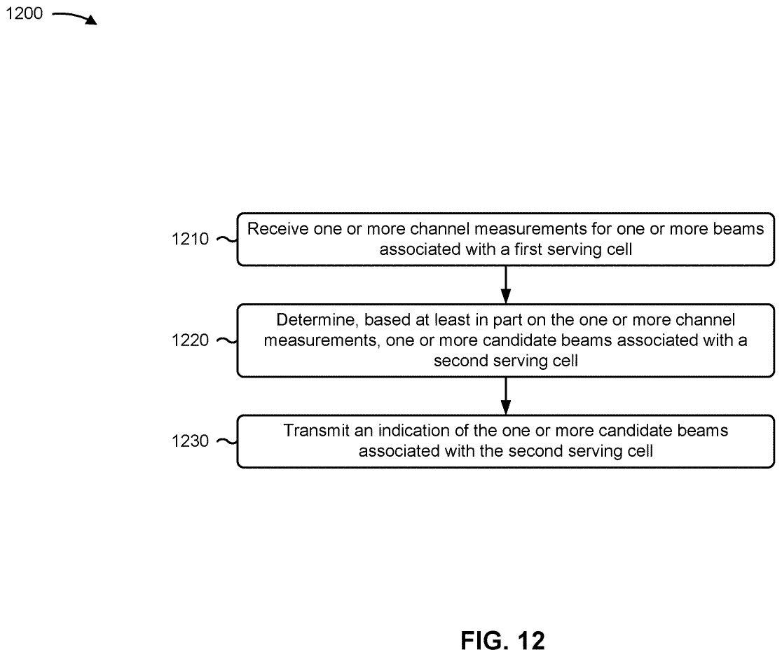

The controller/processor 240 of the network node 110, the controller/processor 280 of the UE 120, and/or any other component(s) of FIG. 2 may perform one or more techniques associated with network node based beam prediction for cell group setup (e.g., for secondary cell group (SCG) setup), as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a first serving cell, one or more channel measurements associated with one or more beams received from the first serving cell; means for receiving, from the first serving cell, an indication of one or more candidate beams associated with a second serving cell based at least in part on the one or more channel measurements associated with the one or more beams received from the first serving cell; and/or means for transmitting, to the second serving cell, a RACH uplink communication based at least in part on the indication of the one or more candidate beams associated with the second serving cell. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) associated with a first serving cell includes means for receiving, from a UE, one or more channel measurements for one or more beams associated with the first serving cell; means for determining, based at least in part on the one or more channel measurements, one or more candidate beams associated with a second serving cell; and/or means for transmitting, to the UE, an indication of the one or more candidate beams associated with the second serving cell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

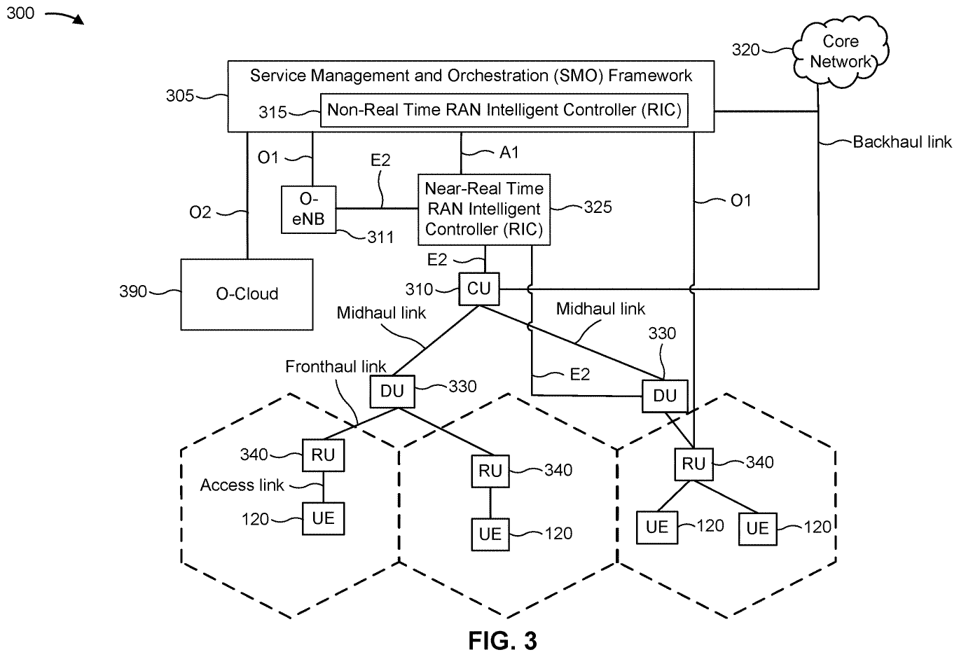

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as A1 interface policies).

As indicated above, FIG. 3 is provided as an example. Other examples may differ from what is described with regard to FIG. 3.

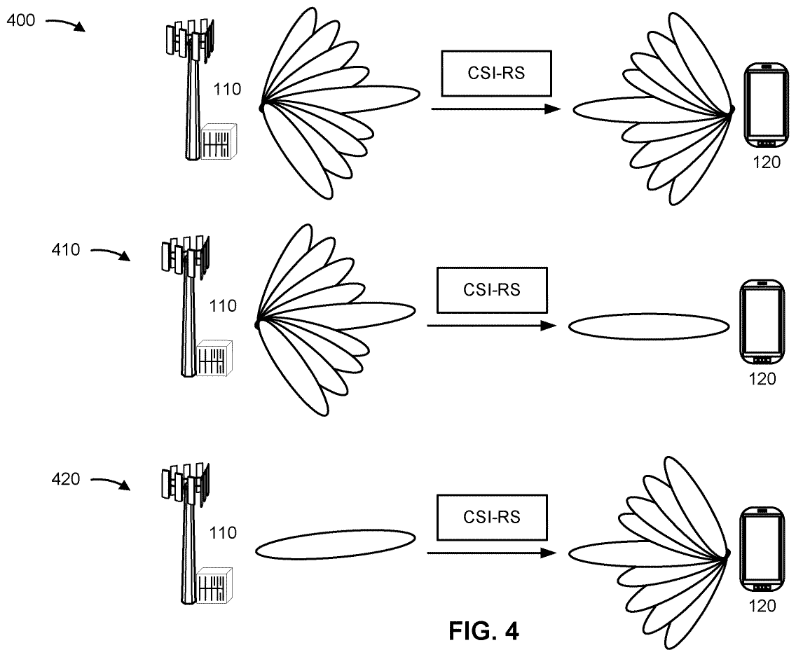

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using channel state information (CSI) reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using medium access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management.

The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR 4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., a few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

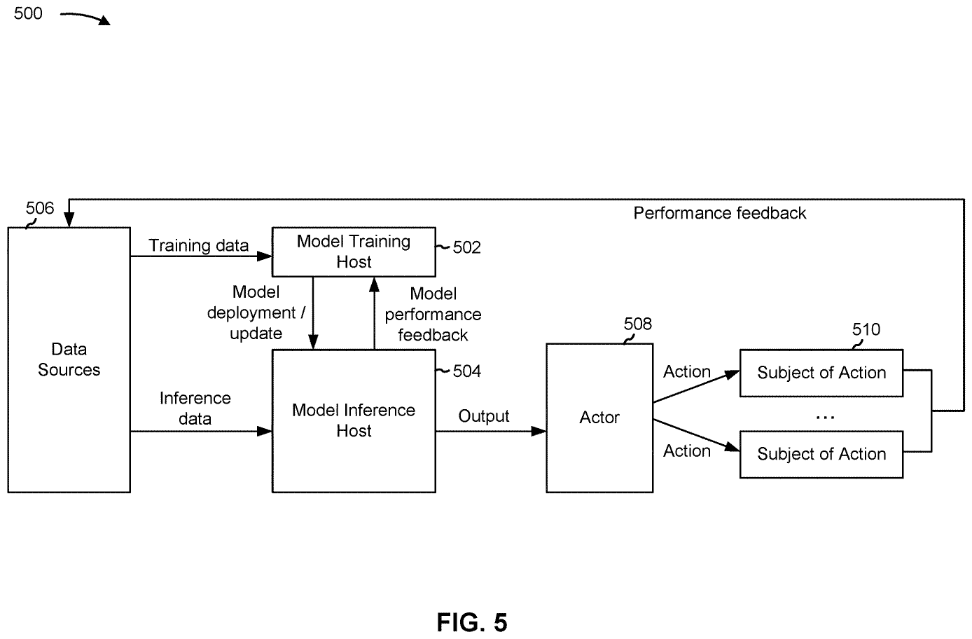

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by artificial intelligence/machine learning (AI/ML) and the associated functional framework (e.g., the artificial intelligence (AI) functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-)configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training a machine learning (ML) model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

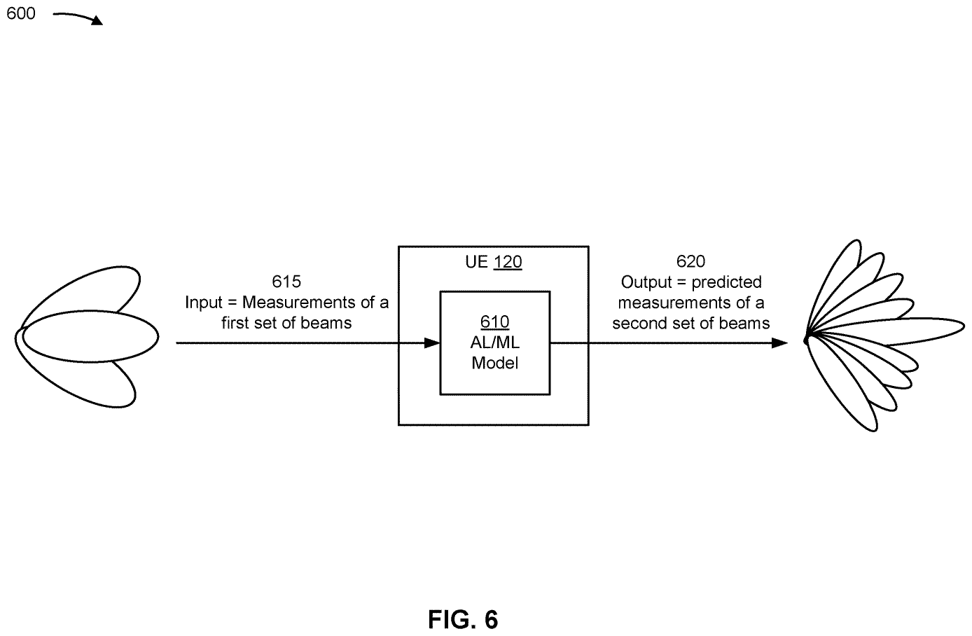

FIG. 6 is a diagram illustrating an example 600 of an AI/ML based beam management, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals via respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook-based spatial domain selection or prediction. As another example, multiple measurement reports or values, collected at different points in time, may be input to the AI/ML model 610. This may enable the AI/ML model 610 to output codebook-based and/or non-codebook-based predictions for a measurement value, an AoD, and/or an AoA, among other examples, of a beam at a future time. The output(s) of the AI/ML model 610, as described herein, may facilitate initial access procedures, SCG setup procedures, beam refinement procedures (e.g., a P2 beam management procedure or a P3 beam management procedure as described above in connection with FIG. 4), link quality or interference adaptation procedures, beam failure and/or beam blockage predictions, and/or radio link failure predictions, among other examples.

In some examples, beam measurement predictions may be performed by a UE (e.g., as depicted in FIG. 6) and/or by a network node 110 in a similar manner as described above. For example, a network node 110 may receive one or more measurements (e.g., performed by a UE 120) and may use an AI/ML model 610 to predict one or more measurements (e.g., of other beams) based at least in part on the one or more measurements performed by the UE 120. For example, predictions may be performed by a network node 110 because the network node 110 may have more processing resources and/or a greater processing capability than a UE 120.

Additionally, the network node 110 may have access to historical measurement reports and/or measurement reports from other UEs that may be used as inputs to the AI/ML model 610 (e.g., which may improve an accuracy of an output of the AI/ML model 610). Predictions may be performed by the UE 120 because the UE 120 may have access to filtered measurements of all beams (e.g., not all measurements may be reported to the network node 110). Additionally, the UE 120 may have information related to the receive beam(s) used to derive or perform the measurements (e.g., which may be a useful input for the AI/ML model 610). As another example, the measurement information at the UE 120 may be “raw” or non-quantized, thereby providing more information that can be input into the AI/ML model 610. Further, the UE 120 may have knowledge of an orientation or a rotational position of the UE 120.

In some examples, the first set of beams (e.g., that are measured) may be referred to as Set B beams and the second set of beams (e.g., that are associated with predicted measurements) may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

In some examples, the AI/ML model 610 may be deployed at the UE 120 to perform cross-frequency-range beam prediction for an SCG setup procedure. In this case, the Set B beams (e.g., measurement resources) may be beams associated with SSBs and/or CSI-RSs in a first serving cell in a master cell group (MCG) operating in FR1 or FR3, and the Set A beams (e.g., prediction targets) may be beams associated with SSBs in a non-activated second serving cell in an SCG operating in FR2. Linkages between the Set B beams and the Set A beams may be indicated, to the UE 120, through either the FR1/FR3 serving cell or the FR2 serving cell, and the AI/ML model 610 deployed on the UE 120 may predict a best SSB and/or RACH resource for communicating with the FR2 serving cell based on measurements of the Set B beams and the linkages between the Set B beams and the Set A beams. Measuring a large amount of SSBs in FR2 for SCG setup may have a high latency and may cause the UE 120 to consume a large amount of power. The AI/ML based cross-frequency-range beam prediction using the AI/ML model 610 deployed at the UE 120 may reduce latency, as compared with the UE 120 measuring the large quantity of SSBs in FR2 for the SCG setup. However, due to limitations of on-device AI/ML computational resources and/or power, some UEs may not be able to efficiently predict FR2 channel characteristics based on the linkages and the AI/ML computations.

Some techniques and apparatuses described herein enable network node based beam prediction for SCG setup. In some aspects, a UE may transmit, to a first serving cell (e.g., of an MCG operating in a first frequency range), one or more channel measurements for one or more beams associated with the first serving cell. A network node (e.g., a network node associated with the first serving cell) may determine one or more candidate beams associated with a second serving cell (e.g., of an SCG operating in a second frequency range) based at least in part on the one or more channel measurements for the one or more beams associated with the first serving cell. For example, the network node may determine the one or more candidate beams associated with the second serving cell based at least in part on the one or more channel measurements for the one or more beams associated with the first serving cell using a machine learning (ML) model. The first serving cell may transmit, and the UE may receive, an indication of the one or more candidate beams associated with the second serving cell. The UE may transmit, to the second serving cell, a RACH uplink communication based at least in part on the indication of the one or more candidate beams associated with the second serving cell. As a result, the AI/ML computations to be performed by the UE for the beam prediction based SCG setup are reduced or eliminated, which enables the beam prediction based SCG setup to be used for more UEs (e.g., including UEs that lack the AI/ML computational resources to efficiently deploy the AI/ML model to predict beam characteristics for the beams associated with the second serving cell). This may result in reduced latency and UE power consumption for an SCG setup procedure.

As indicated above, FIG. 6 is provided as an example. Other examples may differ from what is described with regard to FIG. 6.

FIGS. 7A-7C are diagrams illustrating examples 700A-700C associated with network node based beam prediction for SCG setup, in accordance with the present disclosure. As shown in FIG. 7A, example 700A includes communication between a UE 120, a first serving cell, and a second serving cell. For example, the UE 120 may communicate with a first network node (e.g., network node 110) associated with the first serving cell and a second network node (e.g., network node 110) associated with the second serving cell. In some aspects, the UE 120, the first network node, and the second network node may be included in a wireless network, such as wireless network 100.

In some aspects, the first serving cell may be a serving cell in an MCG, and the second serving cell may be a serving cell in an SCG. In some aspects, the first serving cell may operate in a first frequency range (e.g., FR1 or FR3), and the second serving cell may operate in a second frequency range (e.g., FR2 or FR4). For example, the first serving cell may use the first frequency range (e.g., FR1 or FR3) to transmit and receive RF signals, and the second serving cell may use the second frequency range (e.g., FR2 and FR4) to transmit and receive RF signals. As shown by reference number 702, the first serving cell may transmit RF signals (e.g., in FR2 or FR 4) in one or more directions using a first set of beams associated with the first serving cell. As shown by reference number 704, the second serving cell may transmit RF signals (e.g., in FR2 or FR4) in one or more directions using a second set of beams associated with the second serving cell. In some aspects, the first serving cell and the second serving cell may be co-located. For example, the first network node associated with the first serving cell and the second network node associated with the second serving cell may be network nodes (e.g., DUs or RUs) co-located at the same geographical location, or the first network node associated with the first serving cell and the second network node associated with the second serving cell may be the same network node (e.g., a CU or a DU).

As shown in FIG. 7A, and by reference number 705, the first serving cell may transmit, to the UE 120, a request for channel measurements for beams associated with the first serving cell. The UE 120 may receive the request for the channel measurements. For example, the request may be included in an RRC message, a MAC-CE, or DCI. The request for channel measurements may be a request to perform one or more channel measurements on one more downlink reference signals (e.g., SSBs and/or CSI-RSs) that are transmitted on respective beams from the first serving cell, and to transmit feedback (e.g., a report) indicating the channel measurements to the first serving cell. For example, the request may indicate downlink reference signal resources (e.g., SSB and/or CSI-RS) in which to perform the one or more channel measurements. The one or more channel measurements may be measurements associated with channel characteristics of a downlink channel between the first serving cell and the UE 120. For example, the requested channel measurements may include respective channel impulse response (CIR) measurements for the downlink reference signals transmitted by the first serving cell. Additionally, or alternatively, the requested channel measurements may include L1 RSRP measurements for the downlink reference signals transmitted by the first serving cell.

In some aspects, the first serving cell (e.g., in the MCG) may transmit the request for the channel measurements associated with the first serving cell during a setup procedure for the second serving cell (e.g., a setup procedure for the SCG) for the UE 120. For example, in a case in which the SCG is not yet activated for the UE 120, the first serving cell in the MCG may transmit the request to the UE 120 to initiate activation of the second serving cell in the SCG for the UE 120. In some aspects, during a setup procedure for the second serving cell in the SCG operating in the second frequency range (e.g., FR2 or FR4), the UE 120 may receive, from the first serving cell, the request to perform the one or more channel measurements (e.g., CIR measurements and/or L1 RSRP measurements) on one or more downlink reference signals (e.g., SSBs and/or CSI-RSs) transmitted by the first serving cell in the MCG in the first frequency range (e.g., FR1 or FR3).

As further shown in FIG. 7A, and by reference number 710, the first serving cell may transmit, and the UE 120 may receive, the one or more downlink reference signals (e.g., SSBs and/or CSI-RSs) for the requested one or more channel measurements. For example, the first serving cell in the MCG may transmit the one or more downlink reference signals in the first frequency range (e.g., FR1 or FR3) using different beams associated with the first serving cell. As shown by reference number 715, the UE 120 may perform the one or more channel measurements on the one or more downlink reference signals transmitted by the first serving cell. For example, the UE 120 may perform the requested channel measurements on downlink reference signals (e.g., SSBs and/or CSI-RSs) transmitted by the first serving cell in the downlink reference signal resources indicated in the request. The UE 120 may perform the one or more channel measurements on the one or more downlink reference signals based at least in part on receiving the request for the one or more channel measurements.

In some aspects, the one or more channel measurements may include a respective CIR for each of the one or more downlink reference signals transmitted by the first serving cell (e.g., in FR1 or FR3). Additionally, or alternatively, the one or more channel measurements may include a respective L1 RSRP measurement for each of the one or more downlink reference signals transmitted by the first serving cell (e.g., in FR1 or FR3). In some aspects, performing a channel measurement (e.g., a CIR measurement) for a downlink reference signal may include one or more measurements of the downlink reference signal and one or more calculations to determine the channel measurement or channel characteristic (e.g., CIR) from the measurements of the downlink reference signal.

As further shown in FIG. 7A, and by reference number 720, the UE 120 may transmit, to the first serving cell (e.g., to the first network node associated with the first serving cell), an indication of the one or more channel measurements for the one or more beams associated with the first serving cell. The first serving cell (e.g., the first network node associated with the first serving cell) may receive, from the UE 120, the indication of the one or more channel measurements for the one or more beams associated with the first serving cell. For example, the UE 120 may transmit, to the first serving cell, feedback or a report (e.g., in an uplink channel communication) that includes the indication of the one or more channel measurements based at least in part on receiving the request for the one or more channel measurements. In some aspects, the indication of the one or more channel measurements may indicate a respective CIR for each of the one or more beams associated with the first serving cell (e.g., for each of the one or more downlink reference signals transmitted by the first serving cell). Additionally, or alternatively, the indication of the one or more channel measurements may indicate a respective L1 RSRP measurement for each of the one or more beams associated with the first serving cell (e.g., for each of the one or more downlink reference signals transmitted by the first serving cell).

As further shown in FIG. 7A, and by reference number 725, in some aspects, the first serving cell may communicate with the second serving cell in connection with receiving the indication of the one or more channel measurements from the UE 120. In some aspects, the first serving cell (e.g., the first network node associated with the first serving cell) may communicate with the second serving cell (e.g., the second network node associated with the second serving cell) to obtain information relating to the beams associated with the second serving cell. For example, the first serving cell may communicate with the second serving cell to identify SSB indices and/or CSI-RS resource identifiers that identify downlink reference signal resources (e.g., SSB resources and/or CSI-RS resources) associated with the second serving cell that correspond to different beams associated with the second serving cell.

As shown by reference number 730, the first serving cell (e.g., the first network node associated with the first serving cell) may determine one or more candidate beams associated with the second serving cell based at least in part on the one or more channel measurements of the beams associated with the first serving cell (e.g., the one or more channel measurements received from the UE 120). The one or more candidate beams associated with the second serving cell may be candidate beams to be used for communication between the UE 120 and the second serving cell (e.g., in the SCG). In a case in which a timing advance (TA) configured for the UE 120 in the first serving cell is not valid in the second serving cell, the one or more candidate beams associated with the second serving cell may be one or more candidate beams to be used by the UE 120 in a RACH procedure to establish a connection between the UE 120 and the second serving cell. In some aspects, the one or more candidate beams may include a subset of beams associated with the second serving cell that is smaller than a total set of beams associated with the second serving cell. In some aspects, the first network node associated with the first serving cell may determine, based at least in part on the channel measurements of the downlink reference signals associated with the first serving cell, one or more candidate downlink reference signal resources (e.g., SSB resources and/or CSI-RS resources) associated with the second serving cell that correspond to the one or more candidate beams associated with the second serving cell. In some aspects, in a case in which the TA for the UE 120 in the first serving cell is not valid in the second serving cell, the first network node associated with the first serving cell may identify one or more candidate SSB resources. In this case, the one or more candidate SSB resources may be associated with respective RACH resources that can be used to transmit a RACH uplink communication (e.g., a Message 1 (Msg1) or a Message A (MsgA) in a RACH procedure).

In some aspects, the first network node associated with the first serving cell may use an ML model (e.g., an AI/ML model) to determine the one or more candidate beams associated with the second serving cell. The input to the ML model may include the channel measurements (e.g., the CIRs and/or the L1 RSRP measurements) for the beams associated with the first serving cell (e.g., the channel measurements for the downlink reference signals in the first frequency range). In some aspects, the output of the ML model may identify the one or more candidate downlink reference signal resources (e.g., SSB resources and/or CSI-RS resources) that correspond to the one or more candidate beams associated with the second serving cell. For example, the ML model may output SSB indices of one or more candidate SSB resources associated with the second serving cell. In some aspects, the ML model may also output a respective predicted RSRP value and/or a respective prediction confidence level for each of the one or more candidate downlink reference signal resources (e.g., candidate SSB resources and/or CSI-RS resources). For example, the predicted RSRP value for a candidate downlink reference signal resource may be a predicted mean RSRP value for the candidate downlink reference signal resource (e.g., a prediction of a mean RSRP value that would be measured by the UE 120 on the downlink reference signal transmitted by the second serving cell in the candidate downlink reference signal resource). In some aspects, the prediction confidence level for a candidate downlink reference signal resource may be a confidence level associated with the predicted mean RSRP value. For example, the prediction confidence level may be based at least in part on a standard deviation associated with the predicted mean RSRP value for the candidate downlink reference signal resource.

In some aspects, the first network node associated with the first serving cell may determine the one or more candidate beams (e.g., the one or more candidate downlink reference signal resources) based at least in part on the output of the ML model. For example, the ML model may output a respective predicted mean RSRP value and/or a respective predicted confidence level for each beam associated with the second serving cell (e.g., for each SSB resource associated with the second serving cell), and the first network node may determine the one or more candidate beams by selecting, from the beams associated with the second serving cell, a number of candidate beams (e.g., a number of candidate downlink reference signal resources) based at least in part on the predicted mean RSRP values output by the ML model, the prediction confidence levels output by the ML model, or a combination thereof.

In some aspects, the first network node may determine the one or more candidate beams associated with the second serving cell based at least in part on linkages between one or more beams associated with the first serving cell and one or more candidate beams associated with the second serving cell. For example, the linkages may associate channel measurements (e.g., CIRs and/or L1 RSRP measurements) for a set of beams associated with the first serving cell with one or more candidate beams (e.g., one or more candidate downlink reference signal resources) associated with the second serving cell, with predicted RSRP measurements for beams associated with the second serving cell, and/or for prediction confidence levels associated with the predicted RSRP measurements for the beams associated with the second serving cell. In some aspects, the linkages may be included in the ML model. For example, the linkages may be determined during training of the ML model based on the training data used to train the ML model.

As further shown in FIG. 7A, and by reference number 735, the first serving cell (e.g., the first network node associated with the first serving cell) may transmit, to the UE 120, an indication of the one or more candidate beams associated with the second serving cell. The UE 120 may receive the indication of the one or more candidate beams associated with the second serving cell. For example, the indication may indicate one or more candidate downlink reference signal resources associated with the second serving cell. In some aspects, the indication may indicate multiple candidate beams (e.g., multiple candidate downlink reference signal resources) associated with the second serving cell. In some aspects, in a case in which the TA for the UE 120 in the first serving cell is not valid for the second serving cell, the first serving cell may transmit, and the UE 120 may receive, an indication of multiple candidate SSB resources associated with the second serving cell. In some aspects, the first serving cell may indicate multiple candidate SSB resources associated with the second serving cell (e.g., corresponding to multiple candidate beams associated with the second serving cell) based at least in part on a determination that the TA for the UE 120 is invalid for the second serving cell and based at least in part on a determination that the prediction confidence level for at least one candidate SSB resource does not satisfy (e.g., is less than) a threshold. For example, in the case in which the TA for the UE 120 in the first serving cell is not valid for the second serving cell, the first serving cell may indicate multiple candidate SSB resources associated with the second serving cell in connection with a determination that one or more candidate SSB resources with highest predicted mean RSRP values have confidence levels that do not satisfy the threshold.

In some aspects, the one or more candidate beams (e.g., corresponding to the one or more candidate downlink reference signal resources) associated with the second serving cell are determined/predicted by the first network node associated with the first serving cell (e.g., using the ML model), and the UE 120 may not expect to receive the linkages between the beams associated with the first serving cell and the candidate beams associated with the second serving cell (e.g., the linkages between SSBs and/or CSI-RSs in the first frequency range associated with the first serving cell and SSBs and/or CSI-RSs in the second frequency range associated with the second serving cell) that are used to predict the one or more candidate beams. That is, the UE 120 may receive, from the first serving cell, the indication of the one or more candidate beams associated with the second serving cell without receiving the linkages between the beams associated with the first serving cell and the candidate beams associated with the second serving cell.

In some aspects, the indication of the candidate beams may include an indication of multiple candidate downlink reference signal resources (e.g., multiple SSB resources) and an indication of a priority order associated with the multiple candidate downlink reference signal resources. The priority order associated with the multiple candidate downlink reference signal resources (e.g., the multiple SSB resources) may be an order based at least in part on the predicted mean RSRPs for the candidate downlink reference signal resources, the prediction confidence levels for the candidate downlink reference signal resources, or a combination thereof (e.g., an order based on the predicted mean RSRPs weighted by the respective confidence levels). As shown in example 700B of FIG. 7B, the first serving cell may indicate, to the UE 120, a priority order associated with multiple candidate SSB resources associated with the second serving cell. As shown in FIG. 7B, in example 700B, the priority order for the multiple candidate SSB resources associated with the second serving cell is SSB #3, SSB #2, SSB #5, and SSB #1. The priority order may indicate an order in which the UE 120 is to use the candidate SSB resources to attempt physical broadcast channel (PBCH)/remaining minimum system information (RMSI) decoding and/or to select RACH resources for transmitting a RACH uplink communication (e.g., Msg1 or MsgA) to the second serving cell.

In some aspects, the indication of the candidate beams may include an indication of multiple candidate downlink reference signal resources (e.g., multiple SSB resources) and an indication of the predicted mean RSRP values for the multiple candidate downlink reference signal resources. In some aspects, the indication of the candidate beams may include an indication of multiple candidate downlink reference signal resources (e.g., multiple SSB resources) and an indication of the prediction confidence levels associated with the multiple candidate downlink reference signal resources. In some aspects, the indication of the candidate beams may include an indication of multiple candidate downlink reference signal resources (e.g., multiple SSB resources), an indication of the predicted mean RSRP values for the multiple candidate downlink reference signal resources, and indication of the prediction confidence levels associated with the predicted mean RSRP values of multiple candidate downlink reference signal resources. As shown in example 700C of FIG. 7C, the first serving cell may indicate, to the UE 120, predicted mean RSRP values and prediction confidence levels for multiple candidate SSB resources (SSB #3, SSB #2, SSB #5, and SSB #1) associated with the second serving cell. The prediction confidence level for the predicted mean RSRP value for an SSB resource may be based at least in part on a standard deviation associated with the predicted mean RSRP. As shown in FIG. 7C, a confidence interval, for each predicted mean RSRP value, may be equal to two standard deviations of the predicted mean RSRP value. In this case, a predicted mean RSRP value with a smaller confidence interval or standard deviation may have a higher confidence level, as compared with a predicted mean RSRP value with a larger confidence interval or standard deviation. For example, in FIG. 7C, SSB #2 may have a higher confidence level than SSB #3.

Returning to FIG. 7A, as shown by reference number 740, the second serving cell may transmit SSBs in SSB resources associated with the second serving cell. In some aspects, based at least in part on receiving the indication of multiple candidate SSB resources from the first serving cell, the UE 120 may perform channel measurements (e.g., RSRP measurements) on the SSBs transmitted from the second serving cell in the indicated candidate SSB resources associated with the second serving cell. In some other aspects, (e.g., such as in a case in which the UE 120 receives the indication of the priority order associated with the multiple candidate SSB resources associated with the second serving cell, the indication of the predicted mean RSRP values for the multiple candidate SSB resources, and/or the indication of the prediction confidence levels for the multiple candidate SSB resources), the UE 120 may not perform the channel measurements (e.g., RSRP measurements) on the SSBs transmitted in the indicated candidate SSB resources associated with the second serving cell.

As shown by reference number 745, the UE 120 may select a candidate beam (e.g., a candidate SSB resource) of the one or more candidate beams (e.g., the one or more candidate SSB resources) associated with the second serving cell. For example, in a case in which the TA for the UE 120 in the first serving cell is not valid for the second serving cell, and the UE 120 receives, from the first serving cell, the indication of multiple candidate SSB resources associated with the second serving cell, the UE 120 may select, from the multiple candidate SSB resources, an SSB resource to use for initiating a RACH procedure with the second serving cell (e.g., for PBCH/RMSI decoding and/or for a RACH uplink communication).

In some aspects, the UE 120, based at least in part on receiving the indication of the multiple candidate SSB resources associated with the second serving cell, may select the SSB resource from the multiple candidate SSB resources based at least in part on channel measurements (e.g., RSRP measurements) performed on the SSBs transmitted from the second serving cell in the indicated SSB resources. For example, the UE 120 may select the candidate SSB resource in which the largest RSRP value is measured.

In some aspects, in a case in which the UE 120 receives, from the first serving cell, the indication of the multiple candidate SSB resources associated with the second serving cell and the indication of the priority order associated with the multiple candidate SSB resources, the UE 120 may select the SSB resource from the multiple candidate SSB resources based at least in part on the priority order. In this case, the UE 120 may select the candidate SSB resources to use to attempt decoding PBCH/RMSI transmitted by the second serving cell and/or transmission of a RACH uplink communication (e.g., Msg1 or MsgA) in the order indicated by the priority order associated with the candidate SSB resources.

In some aspects, in a case in which the UE 120 receives, from the first serving cell, the indication of the multiple candidate SSB resources associated with the second serving cell and the indication of the predicted mean RSRP values for the multiple candidate SSB resources, the UE 120 may select the SSB resource (e.g., to use to attempt PBCH decoding and/or transmission of a RACH uplink communication) from the multiple candidate SSB resources based at least in part on the predicted mean RSRP values of the candidate SSB resources. For example, the UE 120 may select, from the indicated candidate SSB resources associated with the second serving cell, an SSB resource having the highest predicted mean RSRP value.

In some aspects, in a case in which the UE 120 receives, from the first serving cell, the indication of the multiple candidate SSB resources associated with the second serving cell and the indication of the prediction confidence levels for the multiple candidate SSB resources, the UE 120 may select the SSB resource (e.g., to use to attempt PBCH decoding and/or transmission of a RACH uplink communication) from the multiple candidate SSB resources based at least in part on the prediction confidence levels. In some aspects, in a case in which the UE 120 receives, from the first serving cell, the indication of the multiple candidate SSB resources associated with the second serving cell, the indication of the predicted mean RSRP values for the multiple candidate SSB resources, and the indication of the prediction confidence levels for the predicted mean RSRP values, the UE 120 may select the SSB resource (e.g., to use to attempt PBCH decoding and/or transmission of a RACH uplink communication) from the multiple candidate SSB resources based at least in part on the predicted mean RSRP values of the candidate SSB resources and the prediction confidence levels for the predicted mean RSRP values. In some cases, the UE 120 may avoid selecting a candidate SSB resource with a high predicted mean RSRP value and a low confidence level. In such cases, the UE 120 may instead select a candidate SSB resource with a slightly lower predicted mean RSRP value (e.g., a medium predicted mean RSRP value) and a higher confidence level. For example, for candidate SSB resources with the predicted mean RSRP values and prediction confidence levels shown in FIG. 7C, the UE 120 may select SSB #2 even though the predicted mean RSRP value for SSB #3 is slightly higher, because the prediction confidence level for SSB #2 is higher than the prediction confidence level for SSB #3. In some aspects, the UE 120 may select a candidate SSB resource having a highest predicted mean RSRP value among candidate SSB resources with prediction confidence levels that satisfy a threshold. In some aspects, the UE 120 may select a candidate SSB resource having a highest prediction confidence level among candidate SSB resources with predicted mean RSRP values that satisfy a threshold. In some aspects, the UE 120 may determine, for each of the candidate SSB resources, a weighted predicted mean RSRP value that is weighted based at least in part on the prediction confidence level for the predicted mean RSRP value, and the UE 120 may select the candidate SSB resource having the highest weighted predicted mean RSRP value.

In some aspects, in a case in which the UE 120 selects the SSB resource based at least in part on the priority order, the predicted mean RSRPs, and/or the prediction confidence levels, the UE 120 may select the SSB resource, from the multiple candidate SSB resources associated with the second serving cell, without performing channel measurements (e.g., RSRP measurements) on the SSBs transmitted by the second serving cell.

As further shown in FIG. 7A, and by reference number 750, the UE 120 may transmit, to the second serving cell, a RACH uplink communication (e.g., Msg1 or MsgA) based at least in part on the selected beam (e.g., the selected SSB resource) associated with the second serving cell. The second serving cell may receive the RACH uplink communication (e.g., Msg1 or MsgA). In some aspects, the UE 120 may transmit the RACH uplink communication (e.g., Msg1 or MsgA) using RACH resources associated with the selected SSB resource. The transmission of Msg1 or MsgA to the second serving cell may initiate the RACH procedure for establishing a connection between the UE 120 and the second serving cell (e.g., to activate the SCG). The transmission of Msg1 or MsgA using the RACH resources associated with the selected SSB may provide an indication to the second serving cell of the selected/preferred beam for communicating with the UE 120 during the RACH procedure (e.g., the beam associated with the selected SSB resource).

As indicated above, FIGS. 7A-7C are provided as examples. Other examples may differ from what is described with respect to FIGS. 7A-C.

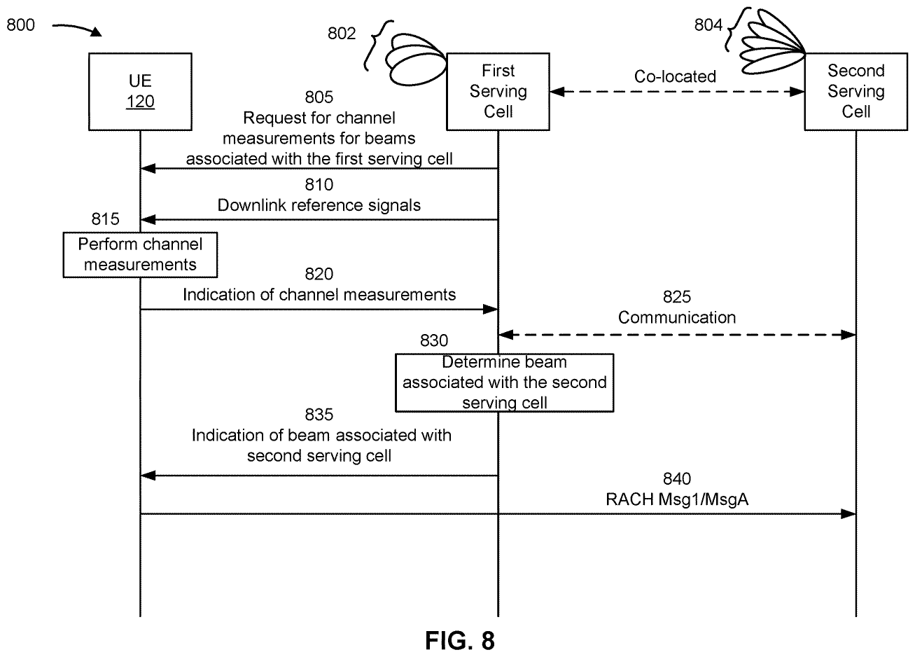

FIG. 8 is a diagram illustrating an example 800 associated with network node based beam prediction for SCG setup, in accordance with the present disclosure. As shown in FIG. 8, example 800 includes communication between a UE 120, a first serving cell, and a second serving cell. For example, the UE 120 may communicate with a first network node (e.g., network node 110) associated with the first serving cell and a second network node (e.g., network node 110) associated with the second serving cell. In some aspects, the UE 120, the first network node, and the second network node may be included in a wireless network, such as wireless network 100.

In some aspects, the first serving cell may be a serving cell in an MCG, and the second serving cell may be a serving cell in an SCG. In some aspects, the first serving cell may operate in a first frequency range (e.g., FR1 or FR3), and the second serving cell may operate in a second frequency range (e.g., FR2 or FR4). For example, the first serving cell may use the first frequency range (e.g., FR1 or FR3) to transmit and receive RF signals, and the second serving cell may use the second frequency range (e.g., FR2 and FR4) to transmit and receive RF signals. As shown by reference number 802, the first serving cell may transmit RF signals (e.g., in FR2 or FR 4) in one or more directions using a first set of beams associated with the first serving cell. As shown by reference number 804, the second serving cell may transmit RF signals (e.g., in FR2 or FR4) in one or more directions using a second set of beams associated with the second serving cell. In some aspects, the first serving cell and the second serving cell may be co-located. For example, the first network node associated with the first serving cell and the second network node associated with the second serving cell may be network nodes (e.g., Dus or Rus) co-located at the same geographical location, or the first network node associated with the first serving cell and the second network node associated with the second serving cell may be the same network node (e.g., a CU or a DU).

As shown in FIG. 8, and by reference number 805, the first serving cell may transmit, to the UE 120, a request for channel measurements for beams associated with the first serving cell. The UE 120 may receive the request for the channel measurements. For example, the request may be included in an RRC message, a MAC-CE, or DCI. The request for channel measurements may be a request to perform one or more channel measurements on one more downlink reference signals (e.g., SSBs and/or CSI-RSs) that are transmitted on respective beams from the first serving cell, and to transmit feedback (e.g., a report) indicating the channel measurements to the first serving cell. For example, the request may indicate downlink reference signal resources (e.g., SSB and/or CSI-RS) in which to perform the one or more channel measurements. The one or more channel measurements may be measurements associated with channel characteristics of a downlink channel between the first serving cell and the UE 120. For example, the requested channel measurements may include respective CIR measurements for the downlink reference signals transmitted by the first serving cell. Additionally, or alternatively, the requested channel measurements may include L1 RSRP measurements for the downlink reference signals transmitted by the first serving cell.

In some aspects, the first serving cell (e.g., in the MCG) may transmit the request for the channel measurements associated with the first serving cell during a setup procedure for the second serving cell (e.g., a setup procedure for the SCG) for the UE 120. For example, in a case in which the SCG is not yet activated for the UE 120, the first serving cell in the MCG may transmit the request to the UE 120 to initiate activation of the second serving cell in the SCG for the UE 120. In some aspects, during a setup procedure for the second serving cell in the SCG operating in the second frequency range (e.g., FR2 or FR4), the UE 120 may receive, from the first serving cell, the request to perform the one or more channel measurements (e.g., CIR measurements and/or L1 RSRP measurements) on one or more downlink reference signals (e.g., SSBs and/or CSI-RSs) transmitted by the first serving cell in the MCG in the first frequency range (e.g., FR1 or FR3).

As further shown in FIG. 8, and by reference number 810, the first serving cell may transmit, and the UE 120 may receive, the one or more downlink reference signals (e.g., SSBs and/or CSI-RSs) for the requested one or more channel measurements. For example, the first serving cell in the MCG may transmit the one or more downlink reference signals in the first frequency range (e.g., FR1 or FR3) using different beams associated with the first serving cell. As shown by reference number 815, the UE 120 may perform the one or more channel measurements on the one or more downlink reference signals transmitted by the first serving cell. For example, the UE 120 may perform the requested channel measurements on downlink reference signals (e.g., SSBs and/or CSI-RSs) transmitted by the first serving cell in the downlink reference signal resources indicated in the request. The UE 120 may perform the one or more channel measurements on the one or more downlink reference signals based at least in part on receiving the request for the one or more channel measurements.

In some aspects, the one or more channel measurements may include a respective CIR for each of the one or more downlink reference signals transmitted by the first serving cell (e.g., in FR1 or FR3). Additionally, or alternatively, the one or more channel measurements may include a respective L1 RSRP measurement for each of the one or more downlink reference signals transmitted by the first serving cell (e.g., in FR1 or FR3).

As further shown in FIG. 8, and by reference number 820, the UE 120 may transmit, to the first serving cell (e.g., to the first network node associated with the first serving cell), an indication of the one or more channel measurements for the one or more beams associated with the first serving cell. The first serving cell (e.g., the first network node associated with the first serving cell) may receive, from the UE 120, the indication of the one or more channel measurements for the one or more beams associated with the first serving cell. For example, the UE 120 may transmit, to the first serving cell, feedback or a report (e.g., in an uplink channel communication) that includes the indication of the one or more channel measurements based at least in part on receiving the request for the one or more channel measurements. In some aspects, the indication of the one or more channel measurements may indicate a respective CIR for each of the one or more beams associated with the first serving cell (e.g., for each of the one or more downlink reference signals transmitted by the first serving cell).

Additionally, or alternatively, the indication of the one or more channel measurements may indicate a respective L1 RSRP measurement for each of the one or more beams associated with the first serving cell (e.g., for each of the one or more downlink reference signals transmitted by the first serving cell).

As further shown in FIG. 8, and by reference number 825, in some aspects, the first serving cell may communicate with the second serving cell in connection with receiving the indication of the one or more channel measurements from the UE 120. In some aspects, the first serving cell (e.g., the first network node associated with the first serving cell) may communicate with the second serving cell (e.g., the second network node associated with the second serving cell) to obtain information relating to the beams associated with the second serving cell. For example, the first serving cell may communicate with the second serving cell to identify SSB indices and/or CSI-RS resource identifiers that identify downlink reference signal resources (e.g., SSB resources and/or CSI-RS resources) associated with the second serving cell that correspond to different beams associated with the second serving cell.

As shown by reference number 830, the first serving cell (e.g., the first network node associated with the first serving cell) may determine a beam associated with the second serving cell based at least in part on the one or more channel measurements of the beams associated with the first serving cell (e.g., the one or more channel measurements received from the UE 120). For example, the first serving cell may determine a single SSB resource associated with the second serving cell, and the single SSB resource may correspond to a single recommended beam to be used for communication between the UE 120 and the second serving cell (e.g., in the SCG). In a case in which the TA configured for the UE 120 in the first serving cell is not valid in the second serving cell, the single SSB resource associated with the second serving cell may correspond to a recommended beam to be used by the UE 120 in a RACH procedure to establish a connection between the UE 120 and the second serving cell.

In some aspects, the first network node associated with the first serving cell may use an ML model (e.g., an AI/ML model) to determine a single downlink reference signal resource (e.g., the single SSB resource) associated with the second serving cell. The input to the ML model may include the channel measurements (e.g., the CIRs and/or the L1 RSRP measurements) for the beams associated with the first serving cell (e.g., the channel measurements for the downlink reference signals in the first frequency range). In some aspects, the output of the ML model may identify the single SSB resource associated with the second serving cell that corresponds to the recommended beam associated with the second serving cell. For example, the ML model may output an SSB index of the single SSB resource associated with the second serving cell. In some aspects, the output of the ML model may identify one or more candidate downlink reference signal resources (e.g., SSB resources and/or CSI-RS resources) that correspond to one or more candidate beams associated with the second serving cell, as well as predicted mean RSRP values and/or prediction confidence levels for the candidate downlink reference signal resources. In this case, the first network node may select the single SSB resource corresponding to the recommended beam associated with the second serving cell from the candidate downlink reference signal resources based at least in part on the predicted mean RSRP values, the prediction confidence values, or a combination thereof. In some aspects, the ML model may output a respective predicted mean RSRP value and/or a respective predicted confidence level for each beam associated with the second serving cell (e.g., for each SSB resource associated with the second serving cell), and the first network node may select the single SSB resource corresponding to the recommended beam associated with the second serving cell based at least in part on the predicted mean RSRP values output by the ML model, the prediction confidence levels output by the ML model, or a combination thereof.

As further shown in FIG. 8, and by reference number 835, the first serving cell (e.g., the first network node associated with the first serving cell) may transmit, to the UE 120, an indication of the beam (e.g., the recommended beam) associated with the second serving cell. The UE 120 may receive the indication of the beam (e.g., the recommended beam) associated with the second serving cell. For example, the indication may indicate a single SSB resource associated with the second serving cell that corresponds to the recommended beam associated with the second serving cell. In some aspects, in a case in which the TA for the UE 120 in the first serving cell is not valid for the second serving cell, the first serving cell may transmit, and the UE 120 may receive, the indication of the single SSB resource associated with the second serving cell (e.g., corresponding to a single recommended beam associated with the second serving cell) based at least in part on a determination that the prediction confidence level for the single SSB resource satisfies (e.g., is greater than or equal to) a threshold.

As further shown in FIG. 8, and by reference number 840, the UE 120 may transmit, to the second serving cell, a RACH uplink communication (e.g., Msg1 or MsgA) based at least in part on the recommended beam (e.g., the indicated single SSB resource) associated with the second serving cell. The second serving cell may receive the RACH uplink communication (e.g., Msg1 or MsgA). In some aspects, the UE 120 may transmit the RACH uplink communication (e.g., Msg1 or MsgA) using RACH resources associated with the indicated single SSB resource associated with the second serving cell. The transmission of Msg1 or MsgA to the second serving cell may initiate the RACH procedure for establishing a connection between the UE 120 and the second serving cell (e.g., to activate the SCG). The transmission of Msg1 or MsgA using the RACH resources associated with the indicated SSB resource may provide an indication to the second serving cell of the recommended beam for communicating with the UE 120 during the RACH procedure (e.g., the beam associated with the indicated SSB resource).

As indicated above, FIG. 8 is provided as an example. Other examples may differ from what is described with respect to FIG. 8.

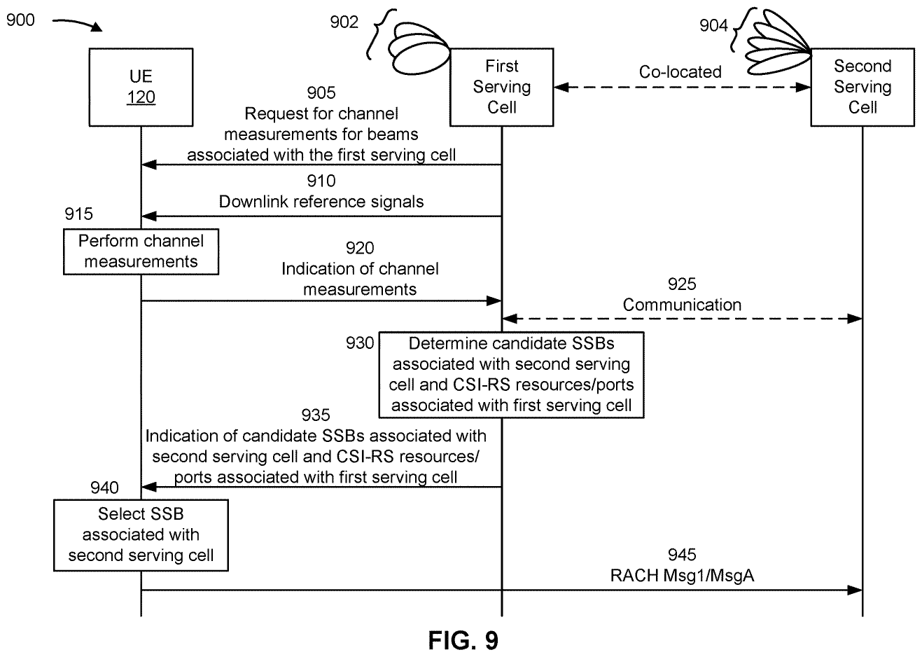

FIG. 9 is a diagram illustrating an example 900 associated with network node based beam prediction for SCG setup, in accordance with the present disclosure. As shown in FIG. 9, example 900 includes communication between a UE 120, a first serving cell, and a second serving cell. For example, the UE 120 may communicate with a first network node (e.g., network node 110) associated with the first serving cell and a second network node (e.g., network node 110) associated with the second serving cell. In some aspects, the UE 120, the first network node, and the second network node may be included in a wireless network, such as wireless network 100.

In some aspects, the first serving cell may be a serving cell in an MCG, and the second serving cell may be a serving cell in an SCG. In some aspects, the first serving cell may operate in a first frequency range (e.g., FR1 or FR3), and the second serving cell may operate in a second frequency range (e.g., FR2 or FR4). For example, the first serving cell may use the first frequency range (e.g., FR1 or FR3) to transmit and receive RF signals, and the second serving cell may use the second frequency range (e.g., FR2 and FR4) to transmit and receive RF signals. As shown by reference number 902, the first serving cell may transmit RF signals (e.g., in FR2 or FR4) in one or more directions using a first set of beams associated with the first serving cell. As shown by reference number 904, the second serving cell may transmit RF signals (e.g., in FR2 or FR4) in one or more directions using a second set of beams associated with the second serving cell. In some aspects, the first serving cell and the second serving cell may be co-located. For example, the first network node associated with the first serving cell and the second network node associated with the second serving cell may be network nodes (e.g., DUs or RUs) co-located at the same geographical location, or the first network node associated with the first serving cell and the second network node associated with the second serving cell may be the same network node (e.g., a CU or a DU).

As shown in FIG. 9, and by reference number 905, the first serving cell may transmit, to the UE 120, a request for channel measurements for beams associated with the first serving cell. The UE 120 may receive the request for the channel measurements. For example, the request may be included in an RRC message, a MAC-CE, or DCI. The request for channel measurements may be a request to perform one or more channel measurements on one more downlink reference signals (e.g., SSBs and/or CSI-RSs) that are transmitted on respective beams from the first serving cell, and to transmit feedback (e.g., a report) indicating the channel measurements to the first serving cell. For example, the request may indicate downlink reference signal resources (e.g., SSB and/or CSI-RS) in which to perform the one or more channel measurements. The one or more channel measurements may be measurements associated with channel characteristics of a downlink channel between the first serving cell and the UE 120. In some aspects, the request for the channel measurements may request that the UE 120 perform initial L1 RSRP measurements for a first set of downlink reference signals (e.g., SSBs and/or CSI-RSs) transmitted by the first serving cell in the first frequency range (e.g., FR1 or FR3). The first set of downlink reference signals, for which the L1 RSRP measurements are requested, may correspond to a first quantity of beams in the first frequency range (e.g., FR1 or FR3), which may be a large quantity.

In some aspects, the first serving cell (e.g., in the MCG) may transmit the request for the channel measurements associated with the first serving cell during a setup procedure for the second serving cell (e.g., a setup procedure for the SCG) for the UE 120. For example, in a case in which the SCG is not yet activated for the UE 120, the first serving cell in the MCG may transmit the request to the UE 120 to initiate activation of the second serving cell in the SCG for the UE 120. In some aspects, during a setup procedure for the second serving cell in the SCG operating in the second frequency range (e.g., FR2 or FR4), the UE 120 may receive, from the first serving cell, the request to perform the initial channel measurements (e.g., L1 RSRP measurements) on the first set of downlink reference signals (e.g., SSBs and/or CSI-RSs) transmitted by the first serving cell in the MCG in the first frequency range (e.g., FR1 or FR3).

As further shown in FIG. 9, and by reference number 910, the first serving cell may transmit, and the UE 120 may receive, the one or more downlink reference signals (e.g., SSBs and/or CSI-RSs) for the requested one or more channel measurements. For example, the first serving cell in the MCG may transmit the first set of downlink reference signals in the first frequency range (e.g., FR1 or FR3) using different beams associated with the first serving cell. As shown by reference number 915, the UE 120 may perform the one or more channel measurements on the one or more downlink reference signals transmitted by the first serving cell. For example, the UE 120 may perform the requested L1 RSRP measurements on the first set of downlink reference signals (e.g., SSBs and/or CSI-RSs) transmitted by the first serving cell in the first frequency range (e.g., FR1 or FR3). The L1 RSRP measurements can have reduced complexity, resulting in reduced processing time for the UE 120, as compared to performing CIR measurements and calculations for the first set of downlink reference signals corresponding to the first quantity of beams in the first frequency range (e.g., FR1 or FR2). The UE 120 may perform the L1 RSRP channel measurements on the first set of downlink reference signals transmitted in the first frequency range (e.g., FR1 or FR3) based at least in part on receiving the request for the one or more channel measurements. In some aspects, the first set of downlink reference signals that are used by the UE 120 to obtain the L1 RSRP measurements may include single port CSI-RS resources only.

As further shown in FIG. 9, and by reference number 920, the UE 120 may transmit, to the first serving cell (e.g., to the first network node associated with the first serving cell), an indication of the one or more channel measurements for the one or more beams associated with the first serving cell. The first serving cell (e.g., the first network node associated with the first serving cell) may receive, from the UE 120, the indication of the one or more channel measurements for the one or more beams associated with the first serving cell. For example, the UE 120 may transmit, to the first serving cell, feedback or a report (e.g., in an uplink channel communication) that includes the indication of the one or more channel measurements based at least in part on receiving the request for the one or more channel measurements. In some aspects, the indication of the one or more channel measurements may indicate a respective L1 RSRP measurement for each beam in the first quantity of beams in the first frequency range (e.g., for each downlink reference signal of the first set of downlink reference signals transmitted by the first serving cell in the first frequency range).

As further shown in FIG. 9, and by reference number 925, in some aspects, the first serving cell may communicate with the second serving cell in connection with receiving the indication of the one or more channel measurements from the UE 120. In some aspects, the first serving cell (e.g., the first network node associated with the first serving cell) may communicate with the second serving cell (e.g., the second network node associated with the second serving cell) to obtain information relating to the beams associated with the second serving cell. For example, the first serving cell may communicate with the second serving cell to identify SSB indices and/or CSI-RS resource identifiers that identify downlink reference signal resources (e.g., SSB resources and/or CSI-RS resources) associated with the second serving cell that correspond to different beams associated with the second serving cell.

As shown by reference number 930, the first serving cell (e.g., the first network node associated with the first serving cell) may determine multiple candidate SSB resources associated with the second serving cell based at least in part on the L1 RSRP measurements of the beams associated with the first serving cell (e.g., the requested channel measurements received from the UE 120). For example, the candidate SSB resources associated with the second serving cell may correspond to candidate beams to be used for communication between the UE 120 and the second serving cell (e.g., in the SCG in the second frequency range). In a case in which the TA configured for the UE 120 in the first serving cell is not valid in the second serving cell, the multiple candidate SSB resources associated with the second serving cell may correspond to multiple candidate beams associated with the second serving cell that are candidates to be used by the UE 120 in a RACH procedure to establish a connection between the UE 120 and the second serving cell. In some aspects, the first serving cell (e.g., the first network node associated with the first serving cell) may also determine, based on the L1 RSRP measurements of the beams associated with the first serving cell, CSI-RS resources and/or CSI-RS ports associated with the first serving cell. For example, the first network node may determine a second quantity of CSI-RS resources and/or ports associated with the first serving cell that correspond to multi-port and beamformed CSI-RS resources in the first frequency range (e.g., FR1 or FR2) to be used to assist the UE 120 to identify CIRs in specific directions associated with the multi-port and beamformed CSI-RS resources. In this case, the second quantity of CSI-RS resources and/or ports associated with the first serving cell may be smaller than the first quantity of beams associated with the first serving cell for which the initial L1 RSRP measurements are performed by the UE 120.

In some aspects, the first network node associated with the first serving cell may use a first ML model (e.g., an AI/ML model) to determine/predict the multiple candidate SSB resources associated with the second serving cell and the CSI-RS resources or ports associated with the first serving cell based at least in part on the L1 RSRP measurements of the first set of beams associated with the first serving cell. In some aspects, the input to the first ML model may include the L1 RSRP measurements for the first quantity of beams associated with the first serving cell (e.g., the channel measurements for the first set of downlink reference signals in the first frequency range), and the output of the ML model may predict the multiple candidate SSB resources associated with the second serving cell, together with the second quantity of CSI-RS resources and/or ports that correspond to multi-port and beamformed CSI-RS resources in the first frequency range (e.g., FR1 or FR2).

As further shown in FIG. 9, and by reference number 935, the first serving cell (e.g., the first network node associated with the first serving cell) may transmit, to the UE 120, an indication of the multiple candidate SSB resources associated with the second serving cell and the CSI-RS resources and/or ports associated with the first serving cell that are determined (e.g., using the first ML model) by the first serving cell. The UE 120 may receive the indication of the multiple candidate SSB resources associated with the second serving cell and the CSI-RS resources and/or ports associated with the first serving cell.

As further shown in FIG. 9, and by reference number 940, the UE 120 may select an SSB resource associated with the second serving cell, from the multiple candidate SSB resources associated with the second serving cell, based at least in part on the indicated CSI-RS resources and/or ports associated with the first serving cell. For example, in a case in which the TA for the UE 120 in the first serving cell is not valid for the second serving cell, the UE 120 may select, from the multiple candidate SSB resources associated with the second serving cell, an SSB resource to use for initiating a RACH procedure with the second serving cell. In some aspects, the UE 120 may be configured with a second ML model (e.g., an AI/ML model), and the UE 120 may use the second ML model to select the SSB resource, from the multiple candidate SSB resources associated with the second serving cell, based at least in part on the indicated CSI-RS resources and/or ports associated with the first serving cell. For example, the UE 120 may calculate CIRs based on the indicated CSI-RS resources and/or ports associated with the first serving cell (e.g., the CSI-RS resources and/or ports that were predicted by the first network node using the first ML model), and the UE 120 may input the CIRs to the second ML model. In this case, the CIRs calculated by the UE 120 and input to the second ML model may be CIRs in specific directions corresponding to multi-port and beamformed CSI-RS resources indicated by the CSI-RS resources and/or ports determined by the first network node using the first ML model. The second ML model may predict a best SSB resource among the multiple candidate SSB resources associated with the second serving cell based at least in part on the CIRs input to the second ML model.

As further shown in FIG. 9, and by reference number 945, the UE 120 may transmit, to the second serving cell, a RACH uplink communication (e.g., Msg1 or MsgA) based at least in part on the selected SSB resource associated with the second serving cell. The second serving cell may receive the RACH uplink communication (e.g., Msg1 or MsgA). In some aspects, the UE 120 may transmit the RACH uplink communication (e.g., Msg1 or MsgA) using RACH resources associated with the selected SSB resource associated with the second serving cell (e.g., the SSB resource selected using the second ML model). The transmission of Msg1 or MsgA to the second serving cell may initiate the RACH procedure for establishing a connection between the UE 120 and the second serving cell (e.g., to activate the SCG). The transmission of Msg1 or MsgA using the RACH resources associated with the selected SSB resource may provide an indication to the second serving cell of the recommended beam for communicating with the UE 120 during the RACH procedure (e.g., the beam associated with the selected SSB resource).

As described above in connection with FIG. 9, in some aspects, the UE 120 may utilize two steps/stages of channel measurements in the first frequency range (e.g., FR1 or FR3) to predict a best SSB resource associated with the second serving cell operating in the second frequency range (e.g., FR2 or FR4). The two steps/or stages of channel measurements may include initial L1 RSRP measurements for a first quantity of beams associated with the first serving cell (e.g., in the first frequency range), and then CIR calculations based on a second quantity (e.g., smaller than the first quantity) of CSI-RS resources and/or ports predicted by the first network node (e.g., using the first ML model) and indicated to the UE 120. As a result, the processing time and processing resources used by the UE 120 in performing the channel measurements may be reduced, as compared with performing CIR measurements and calculations for all of the first quantity of beams associated with the first serving cell. Furthermore, the second ML model used by the UE 120 to predict the best SSB resource, among multiple candidate SSB resources associated with the second serving cell that are predicted by the network node (e.g., using the first ML model), may be less complex (e.g., resulting in utilization of fewer computational resources and less power consumption by the UE 120), as compared to an ML model that predicts the best SSB resource, from a larger quantity of SSB resources associated with the second serving cell, based on CIRs for all of the first quantity of beams associated with the first serving cell.

As indicated above, FIG. 9 is provided as an example. Other examples may differ from what is described with respect to FIG. 9.

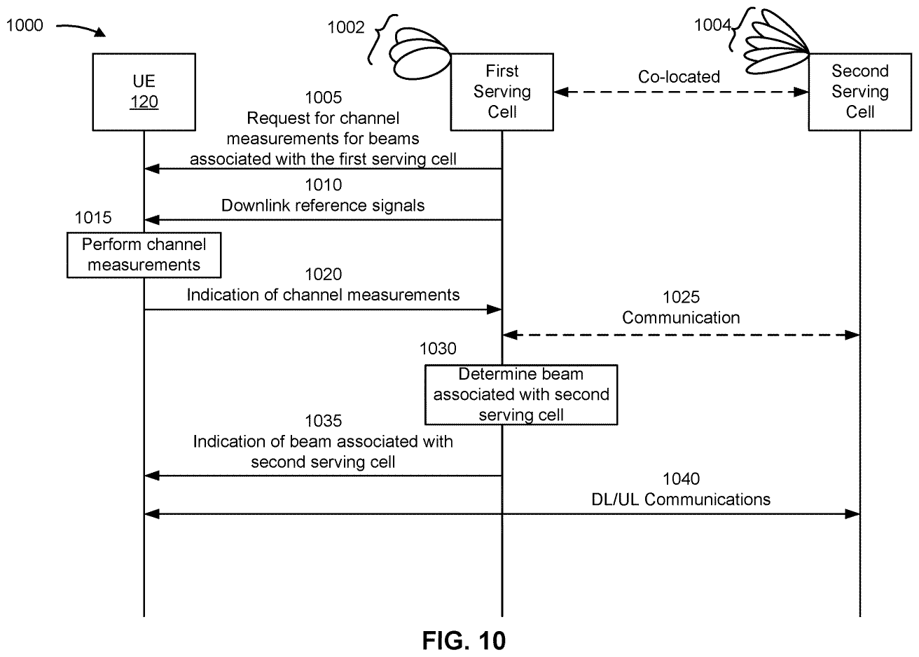

FIG. 10 is a diagram illustrating an example 1000 associated with network node based beam prediction for SCG setup, in accordance with the present disclosure. As shown in FIG. 10, example 1000 includes communication between a UE 120, a first serving cell, and a second serving cell. For example, the UE 120 may communicate with a first network node (e.g., network node 110) associated with the first serving cell and a second network node (e.g., network node 110) associated with the second serving cell. In some aspects, the UE 120, the first network node, and the second network node may be included in a wireless network, such as wireless network 100.

In some aspects, the first serving cell may be a serving cell in an MCG, and the second serving cell may be a serving cell in an SCG. In some aspects, the first serving cell may operate in a first frequency range (e.g., FR1 or FR3), and the second serving cell may operate in a second frequency range (e.g., FR2 or FR4). For example, the first serving cell may use the first frequency range (e.g., FR1 or FR3) to transmit and receive RF signals, and the second serving cell may use the second frequency range (e.g., FR2 and FR4) to transmit and receive RF signals. As shown by reference number 1002, the first serving cell may transmit RF signals (e.g., in FR2 or FR4) in one or more directions using a first set of beams associated with the first serving cell. As shown by reference number 1004, the second serving cell may transmit RF signals (e.g., in FR2 or FR4) in one or more directions using a second set of beams associated with the second serving cell. In some aspects, the first serving cell and the second serving cell may be co-located. For example, the first network node associated with the first serving cell and the second network node associated with the second serving cell may be network nodes (e.g., DUs or RUs) co-located at the same geographical location, or the first network node associated with the first serving cell and the second network node associated with the second serving cell may be the same network node (e.g., a CU or a DU).

As shown in FIG. 10, and by reference number 1005, the first serving cell may transmit, to the UE 120, a request for channel measurements for beams associated with the first serving cell. The UE 120 may receive the request for the channel measurements. For example, the request may be included in an RRC message, a MAC-CE, or DCI. The request for channel measurements may be a request to perform one or more channel measurements on one more downlink reference signals (e.g., SSBs and/or CSI-RSs) that are transmitted on respective beams from the first serving cell, and to transmit feedback (e.g., a report) indicating the channel measurements to the first serving cell. For example, the request may indicate downlink reference signal resources (e.g., SSB and/or CSI-RS) in which to perform the one or more channel measurements. The one or more channel measurements may be measurements associated with channel characteristics of a downlink channel between the first serving cell and the UE 120. For example, the requested channel measurements may include respective CIR measurements for the downlink reference signals transmitted by the first serving cell. Additionally, or alternatively, the requested channel measurements may include L1 RSRP measurements for the downlink reference signals transmitted by the first serving cell.

In some aspects, the first serving cell (e.g., in the MCG) may transmit the request for the channel measurements associated with the first serving cell during a setup procedure for the second serving cell (e.g., a setup procedure for the SCG) for the UE 120. For example, in a case in which the SCG is not yet activated for the UE 120, the first serving cell in the MCG may transmit the request to the UE 120 to initiate activation of the second serving cell in the SCG for the UE 120. In some aspects, during a setup procedure for the second serving cell in the SCG operating in the second frequency range (e.g., FR2 or FR4), the UE 120 may receive, from the first serving cell, the request to perform the one or more channel measurements (e.g., CIR measurements and/or L1 RSRP measurements) on one or more downlink reference signals (e.g., SSBs and/or CSI-RSs) transmitted by the first serving cell in the MCG in the first frequency range (e.g., FR1 or FR3).

As further shown in FIG. 10, and by reference number 1010, the first serving cell may transmit, and the UE 120 may receive, the one or more downlink reference signals (e.g., SSBs and/or CSI-RSs) for the requested one or more channel measurements. For example, the first serving cell in the MCG may transmit the one or more downlink reference signals in the first frequency range (e.g., FR1 or FR3) using different beams associated with the first serving cell. As shown by reference number 1015, the UE 120 may perform the one or more channel measurements on the one or more downlink reference signals transmitted by the first serving cell. For example, the UE 120 may perform the requested channel measurements on downlink reference signals (e.g., SSBs and/or CSI-RSs) transmitted by the first serving cell in the downlink reference signal resources indicated in the request. The UE 120 may perform the one or more channel measurements on the one or more downlink reference signals based at least in part on receiving the request for the one or more channel measurements.

In some aspects, the one or more channel measurements may include a respective CIR for each of the one or more downlink reference signals transmitted by the first serving cell (e.g., in FR1 or FR3). Additionally, or alternatively, the one or more channel measurements may include a respective L1 RSRP measurement for each of the one or more downlink reference signals transmitted by the first serving cell (e.g., in FR1 or FR3).

As further shown in FIG. 10, and by reference number 1020, the UE 120 may transmit, to the first serving cell (e.g., to the first network node associated with the first serving cell), an indication of the one or more channel measurements for the one or more beams associated with the first serving cell. The first serving cell (e.g., the first network node associated with the first serving cell) may receive, from the UE 120, the indication of the one or more channel measurements for the one or more beams associated with the first serving cell. For example, the UE 120 may transmit, to the first serving cell, feedback or a report (e.g., in an uplink channel communication) that includes the indication of the one or more channel measurements based at least in part on receiving the request for the one or more channel measurements. In some aspects, the indication of the one or more channel measurements may indicate a respective CIR for each of the one or more beams associated with the first serving cell (e.g., for each of the one or more downlink reference signals transmitted by the first serving cell). Additionally, or alternatively, the indication of the one or more channel measurements may indicate a respective L1 RSRP measurement for each of the one or more beams associated with the first serving cell (e.g., for each of the one or more downlink reference signals transmitted by the first serving cell).

As further shown in FIG. 10, and by reference number 1025, in some aspects, the first serving cell may communicate with the second serving cell in connection with receiving the indication of the one or more channel measurements from the UE 120. In some aspects, the first serving cell (e.g., the first network node associated with the first serving cell) may communicate with the second serving cell (e.g., the second network node associated with the second serving cell) to obtain information relating to the beams associated with the second serving cell. For example, the first serving cell may communicate with the second serving cell to identify SSB indices and/or CSI-RS resource identifiers that identify downlink reference signal resources (e.g., SSB resources and/or CSI-RS resources) associated with the second serving cell that correspond to different beams associated with the second serving cell.

As shown by reference number 1030, the first serving cell (e.g., the first network node associated with the first serving cell) may determine a beam associated with the second serving cell based at least in part on the one or more channel measurements of the beams associated with the first serving cell (e.g., the one or more channel measurements received from the UE 120). For example, the first serving cell may determine a downlink reference signal resource that corresponds to a single recommended beam associated with the second serving cell. In a case in which the TA configured for the UE 120 in the first serving cell is valid in the second serving cell, the single recommended beam may be a recommended beam for communication between the UE 120 and the second serving cell, and the single recommended beam may correspond to an SSB resource associated with the second serving cell or a CSI-RS resource associated with the second serving cell.

In some aspects, the first network node associated with the first serving cell may use an ML model (e.g., an AI/ML model) to determine the downlink reference signal resource (e.g., the SSB resource or CSI-RS resource) associated with the second serving cell that corresponds to the recommended beam. The input to the ML model may include the channel measurements (e.g., the CIRs and/or the L1 RSRP measurements) for the beams associated with the first serving cell (e.g., the channel measurements for the downlink reference signals in the first frequency range). In some aspects, the output of the ML model may identify a single SSB resource or CSI-RS resource associated with the second serving cell that corresponds to the recommended beam associated with the second serving cell. In some aspects, the output of the ML model may identify one or more candidate downlink reference signal resources (e.g., SSB resources and/or CSI-RS resources) that correspond to one or more candidate beams associated with the second serving cell, as well as predicted mean RSRP values and/or prediction confidence levels for the candidate downlink reference signal resources. In this case, the first network node may select the single SSB resource or CSI-RS resource that corresponds to the recommended beam associated with the second serving cell from the candidate downlink reference signal resources based at least in part on the predicted mean RSRP values, the prediction confidence values, or a combination thereof.

As further shown in FIG. 10, and by reference number 1035, the first serving cell (e.g., the first network node associated with the first serving cell) may transmit, to the UE 120, an indication of the beam (e.g., the recommended beam) associated with the second serving cell. The UE 120 may receive the indication of the beam (e.g., the recommended beam) associated with the second serving cell. In some aspects, in a case in which the TA for the UE 120 in the first serving cell is valid for the second serving cell, the indication may indicate a downlink reference signal resource (e.g., an SSB resource or a CSI-RS resource) associated with the second serving cell as a default quasi co-location (QCL)-TypeD source for the recommended beam to be used for communication between the UE 120 and the second serving cell. In some aspects, in the case in which the TA for the UE 120 in the first serving cell is valid for the second serving cell, the first serving cell may transmit, and the UE 120 may receive, the indication of the single recommended beam associated with the second serving cell (e.g., the indication of the downlink reference signal resource as the default QCL-TypeD source for the single recommended beam) based at least in part on a determination that the prediction confidence level for the downlink reference signal resource corresponding to the single recommended beam satisfies (e.g., is greater than or equal to) a threshold.

As further shown in FIG. 10, and by reference number 1040, the UE 120 may communicate with the second serving cell using the recommended beam associated with the second serving cell. In some aspects, in the case in which the TA for the UE 120 in the first serving cell is valid for the second serving cell, the UE 120 may transmit uplink communications to the second serving cell and/or receive downlink communications from the second serving cell using the recommended beam indicated by the first serving cell, without first performing a RACH procedure.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with network node based beam prediction for SCG setup.

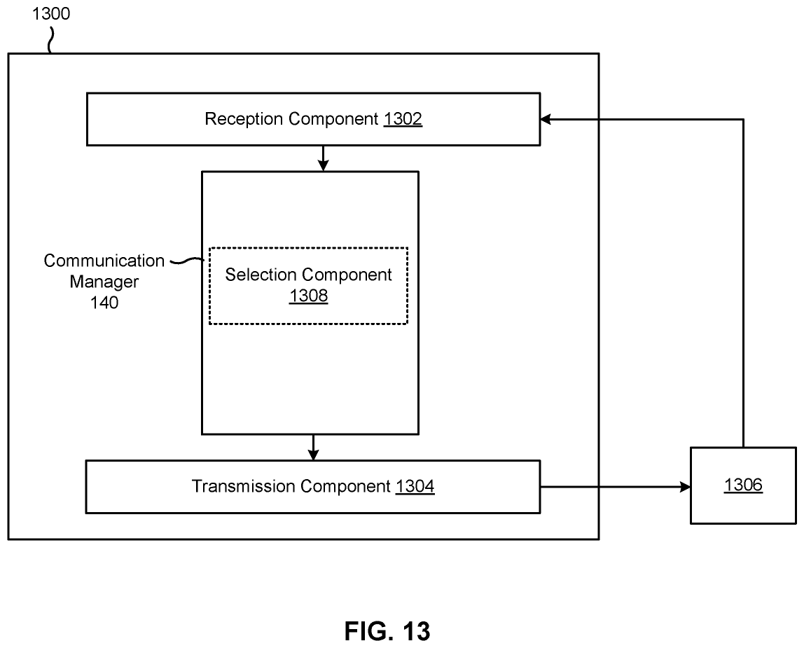

As shown in FIG. 11, in some aspects, process 1100 may include transmitting, to a first serving cell, one or more channel measurements associated with one or more beams received from the first serving cell (block 1110). For example, the UE (e.g., using communication manager 140 and/or transmission component 1304, depicted in FIG. 13) may transmit, to a first serving cell, one or more channel measurements associated with one or more beams received from the first serving cell, as described above.

As further shown in FIG. 11, in some aspects, process 1100 may include receiving, from the first serving cell, an indication of one or more candidate beams associated with a second serving cell based at least in part on the one or more channel measurements associated with the one or more beams received from the first serving cell (block 1120). For example, the UE (e.g., using communication manager 140 and/or reception component 1302, depicted in FIG. 13) may receive, from the first serving cell, an indication of one or more candidate beams associated with a second serving cell based at least in part on the one or more channel measurements associated with the one or more beams received from the first serving cell, as described above.

As further shown in FIG. 11, in some aspects, process 1100 may include transmitting, to the second serving cell, a RACH uplink communication based at least in part on the indication of the one or more candidate beams associated with the second serving cell (block 1130). For example, the UE (e.g., using communication manager 140 and/or transmission component 1304, depicted in FIG. 13) may transmit, to the second serving cell, a RACH uplink communication based at least in part on the indication of the one or more candidate beams associated with the second serving cell, as described above.

Process 1100 may include additional aspects, such as any single aspect or any combination of aspects described below and/or in connection with one or more other processes described elsewhere herein.

In a first aspect, process 1100 includes receiving, from the first serving cell, a request to perform the one or more channel measurements on one or more downlink reference signals associated with the one or more beams received from the first serving cell, wherein transmitting the one or more channel measurements includes transmitting the one or more channel measurements to the first serving cell based at least in part on receiving the request to perform the one or more channel measurements.

In a second aspect, alone or in combination with the first aspect, the one or more channel measurements include at least one of a CIR measurement or an RSRP measurement.

In a third aspect, alone or in combination with one or more of the first and second aspects, the first serving cell is associated with a first frequency band and the second serving cell is associated with a second frequency band.

In a fourth aspect, alone or in combination with one or more of the first through third aspects, the first serving cell is associated with an MCG and the second serving cell is associated with an SCG.

In a fifth aspect, alone or in combination with one or more of the first through fourth aspects, receiving the indication of the one or more candidate beams associated with the second serving cell includes receiving, from the first serving cell, the indication of the one or more candidate beams associated with the second serving cell without receiving an indication of linkages between the one or more beams received from the first serving cell and the one or more candidate beams associated with the second serving cell.

In a sixth aspect, alone or in combination with one or more of the first through fifth aspects, the indication of the one or more candidate beams associated with the second serving cell indicates multiple candidate beams associated with the second serving cell, and transmitting the RACH uplink communication based at least in part on the indication of the one or more candidate beams associated with the second serving cell includes transmitting the RACH uplink communication to the second serving cell using a selected beam of the multiple candidate beams associated with the second serving cell.

In a seventh aspect, alone or in combination with one or more of the first through sixth aspects, the indication of the one or more candidate beams includes an indication of multiple candidate downlink reference signal resources associated with the second serving cell, wherein each candidate downlink reference signal resource of the multiple candidate downlink reference signal resources corresponds to a respective candidate beam of the multiple candidate beams, and wherein transmitting the RACH uplink communication to the second serving cell using the selected beam includes transmitting the RACH uplink communication to the second serving cell based at least in part on a selected candidate downlink reference signal resource of the multiple candidate downlink reference signal resources.

In an eighth aspect, alone or in combination with one or more of the first through seventh aspects, process 1100 includes selecting the selected candidate downlink reference signal resource based at least in part on measurements of the multiple candidate downlink reference signal resources.

In a ninth aspect, alone or in combination with one or more of the first through eighth aspects, receiving the indication of the one or more candidate beams associated with the second serving cell includes receiving the indication of the multiple candidate downlink reference signal resources and an indication of a priority order associated with the multiple candidate downlink reference signal resources, wherein the selected candidate downlink reference signal resource is based at least in part on the priority order associated with the multiple candidate downlink reference signal resources.

In a tenth aspect, alone or in combination with one or more of the first through ninth aspects, receiving the indication of the one or more candidate beams associated with the second serving cell includes receiving the indication of the multiple candidate downlink reference signal resources and an indication of predicted mean RSRP values for the multiple candidate downlink reference signal resources, wherein the selected candidate downlink reference signal resource is based at least in part on the mean predicted RSRP values for the multiple candidate downlink reference signal resources.

In an eleventh aspect, alone or in combination with one or more of the first through tenth aspects, receiving the indication of the one or more candidate beams associated with the second serving cell includes receiving the indication of the multiple candidate downlink reference signal resources, an indication of predicted mean RSRP values for the multiple candidate downlink reference signal resources, and an indication of prediction confidence levels for the predicted mean RSRP values, wherein the selected candidate downlink reference signal resource is based at least in part on the predicted mean RSRP values for the multiple downlink candidate reference signal resources and the prediction confidence levels for the predicted mean RSRP values.

In a twelfth aspect, alone or in combination with one or more of the first through eleventh aspects, the multiple candidate downlink reference signal resources associated with the second serving cell include multiple candidate SSB resources associated with the second serving cell, and receiving the indication of the one or more candidate beams associated with the second serving cell includes receiving an indication of the multiple candidate SSB resources associated with the second serving cell and an indication of one or more CSI-RS resources or ports associated with the first serving cell, wherein the selected candidate downlink reference signal resource is a selected candidate SSB resource based at least in part on the multiple candidate SSB resources associated with the second serving cell and the one or more CSI-RS resources or ports associated with the first serving cell.

In a thirteenth aspect, alone or in combination with one or more of the first through twelfth aspects, process 1100 includes selecting the selected candidate SSB resource based at least in part on the multiple candidate SSB resources associated with the second serving cell and the one or more CSI-RS resources or ports associated with the first serving cell using a machine learning model.

In a fourteenth aspect, alone or in combination with one or more of the first through thirteenth aspects, the indication of the one or more candidate beams associated with the second serving cell indicates a single beam associated with the second serving cell, and transmitting the RACH uplink communication based at least in part on the indication of the one or more candidate beams associated with the second serving cell includes transmitting the RACH uplink communication to the second serving cell using the single beam associated with the second serving cell.

In a fifteenth aspect, alone or in combination with one or more of the first through fourteenth aspects, the indication of the one or more candidate beams includes an indication of a downlink reference signal resource associated with the second serving cell, wherein the downlink reference signal resource corresponds to the single beam, and wherein transmitting the RACH uplink communication to the second serving cell using the single beam includes transmitting the RACH uplink communication to the second serving cell based at least in part on the downlink reference signal resource.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with network node based beam prediction for SCG setup.

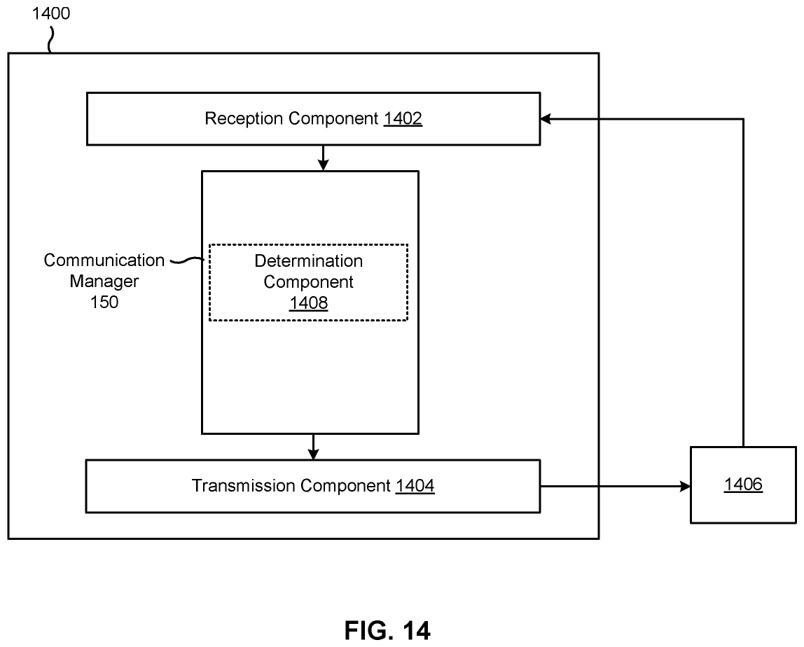

As shown in FIG. 12, in some aspects, process 1200 may include receiving, from a UE, one or more channel measurements for one or more beams associated with a first serving cell (block 1210). For example, the network node (e.g., using communication manager 150 and/or reception component 1402, depicted in FIG. 14) may receive, from a UE, one or more channel measurements for one or more beams associated with a first serving cell, as described above.

As further shown in FIG. 12, in some aspects, process 1200 may include determining, based at least in part on the one or more channel measurements, one or more candidate beams associated with a second serving cell (block 1220). For example, the network node (e.g., using communication manager 150 and/or determination component 1408, depicted in FIG. 14) may determine, based at least in part on the one or more channel measurements, one or more candidate beams associated with a second serving cell, as described above.

As further shown in FIG. 12, in some aspects, process 1200 may include transmitting, to the UE, an indication of the one or more candidate beams associated with the second serving cell (block 1230). For example, the network node (e.g., using communication manager 150 and/or transmission component 1404, depicted in FIG. 14) may transmit, to the UE, an indication of the one or more candidate beams associated with the second serving cell, as described above.

Process 1200 may include additional aspects, such as any single aspect or any combination of aspects described below and/or in connection with one or more other processes described elsewhere herein.

In a first aspect, determining, based at least in part on the one or more channel measurements, the one or more candidate beams associated with the second serving cell includes determining the one or more candidate beams associated with a second serving cell based at least in part on the one or more channel measurements using a machine learning model.

In a second aspect, alone or in combination with the first aspect, process 1200 includes transmitting, to the UE, a request to perform the one or more channel measurements on one or more downlink reference signals associated with the one or more beams associated with the first serving cell.

In a third aspect, alone or in combination with one or more of the first and second aspects, the one or more channel measurements include at least one of a CIR measurement or an RSRP measurement.

In a fourth aspect, alone or in combination with one or more of the first through third aspects, the first serving cell is associated with a first frequency band and the second serving cell is associated with a second frequency band.

In a fifth aspect, alone or in combination with one or more of the first through fourth aspects, the first serving cell is associated with an MCG and the second serving cell is associated with an SCG.

In a sixth aspect, alone or in combination with one or more of the first through fifth aspects, transmitting the indication of the one or more candidate beams associated with the second serving cell includes transmitting, to the UE, the indication of the one or more candidate beams associated with the second serving cell without transmitting an indication of linkages between the one or more beams associated with the first serving cell and the one or more candidate beams associated with the second serving cell.

In a seventh aspect, alone or in combination with one or more of the first through sixth aspects, the indication of the one or more candidate beams associated with the second serving cell indicates multiple candidate beams associated with the second serving cell.

In an eighth aspect, alone or in combination with one or more of the first through seventh aspects, the indication of the one or more candidate beams includes an indication of multiple candidate downlink reference signal resources associated with the second serving cell, and each candidate downlink reference signal resource of the multiple candidate downlink reference signal resources corresponds to a respective candidate beam of the multiple candidate beams.

In a ninth aspect, alone or in combination with one or more of the first through eighth aspects, transmitting the indication of the one or more candidate beams associated with the second serving cell includes transmitting the indication of the multiple candidate downlink reference signal resources and an indication of a priority order associated with the multiple candidate downlink reference signal resources.

In a tenth aspect, alone or in combination with one or more of the first through ninth aspects, transmitting the indication of the one or more candidate beams associated with the second serving cell includes transmitting the indication of the multiple candidate downlink reference signal resources and an indication of predicted mean RSRP values for the multiple candidate downlink reference signal resources.

In an eleventh aspect, alone or in combination with one or more of the first through tenth aspects, transmitting the indication of the one or more candidate beams associated with the second serving cell includes transmitting the indication of the multiple candidate downlink reference signal resources, an indication of predicted mean RSRP values for the multiple candidate downlink reference signal resources, and an indication of prediction confidence levels for the predicted mean RSRP values.

In a twelfth aspect, alone or in combination with one or more of the first through eleventh aspects, the multiple candidate downlink reference signal resources associated with the second serving cell include multiple candidate SSB resources associated with the second serving cell, and transmitting the indication of the one or more candidate beams associated with the second serving cell includes transmitting an indication of the multiple candidate SSB resources associated with the second serving cell and an indication of one or more CSI-RS resources or ports associated with the first serving cell.

In a thirteenth aspect, alone or in combination with one or more of the first through twelfth aspects, the indication of the one or more candidate beams associated with the second serving cell indicates a single beam associated with the second serving cell.

In a fourteenth aspect, alone or in combination with one or more of the first through thirteenth aspects, the indication of the one or more candidate beams includes an indication of a downlink reference signal resource associated with the second serving cell, and the downlink reference signal resource corresponds to the single beam associated with the second serving cell.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a selection component 1308, among other examples.

In some aspects, the apparatus 1300 may be configured to perform one or more operations described herein in connection with FIGS. 7A-7C and 8-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The transmission component 1304 may transmit, to a first serving cell, one or more channel measurements associated with one or more beams received from the first serving cell. The reception component 1302 may receive, from the first serving cell, an indication of one or more candidate beams associated with a second serving cell based at least in part on the one or more channel measurements associated with the one or more beams received from the first serving cell. The transmission component 1304 may transmit, to the second serving cell, a RACH uplink communication based at least in part on the indication of the one or more candidate beams associated with the second serving cell.

The reception component 1302 may receive, from the first serving cell, a request to perform the one or more channel measurements on one or more downlink reference signals associated with the one or more beams received from the first serving cell, wherein transmitting the one or more channel measurements comprises transmitting the one or more channel measurements to the first serving cell based at least in part on receiving the request to perform the one or more channel measurements.

The selection component 1308 may select the selected candidate downlink reference signal resource based at least in part on measurements of the multiple candidate downlink reference signal resources.

The selection component 1308 may select the selected candidate SSB resource based at least in part on the multiple candidate SSB resources associated with the second serving cell and the one or more CSI-RS resources or ports associated with the first serving cell using a machine learning model.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a determination component 1408, among other examples.

In some aspects, the apparatus 1400 may be configured to perform one or more operations described herein in connection with FIGS. 7A-7C and 8-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The reception component 1402 may receive, from a UE, one or more channel measurements for one or more beams associated with a first serving cell. The determination component 1408 may determine, based at least in part on the one or more channel measurements, one or more candidate beams associated with a second serving cell. The transmission component 1404 may transmit, to the UE, an indication of the one or more candidate beams associated with the second serving cell.

The determination component 1408 may determine the one or more candidate beams associated with the second serving cell using a machine learning model.

The transmission component 1404 may transmit, to the UE, a request to perform the one or more channel measurements on one or more downlink reference signals associated with the one or more beams associated with the first serving cell.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by an apparatus of a user equipment (UE), comprising: transmitting, to a first serving cell, one or more channel measurements associated with one or more beams received from the first serving cell; receiving, from the first serving cell, an indication of one or more candidate beams associated with a second serving cell based at least in part on the one or more channel measurements associated with the one or more beams received from the first serving cell; and transmitting, to the second serving cell, a random access channel (RACH) uplink communication based at least in part on the indication of the one or more candidate beams associated with the second serving cell.
Aspect 2: The method of Aspect 1, further comprising: receiving, from the first serving cell, a request to perform the one or more channel measurements on one or more downlink reference signals associated with the one or more beams received from the first serving cell, wherein transmitting the one or more channel measurements comprises transmitting the one or more channel measurements to the first serving cell based at least in part on receiving the request to perform the one or more channel measurements.
Aspect 3: The method of any of Aspects 1-2, wherein the one or more channel measurements include at least one of a channel impulse response (CIR) measurement or a reference signal received power (RSRP) measurement.
Aspect 4: The method of any of Aspects 1-3, wherein the first serving cell is associated with a first frequency band and the second serving cell is associated with a second frequency band.
Aspect 5: The method of any of Aspects 1-4, wherein the first serving cell is associated with a master cell group (MCG) and the second serving cell is associated with a secondary cell group (SCG).
Aspect 6: The method of any of Aspects 1-5, wherein receiving the indication of the one or more candidate beams associated with the second serving cell comprises: receiving, from the first serving cell, the indication of the one or more candidate beams associated with the second serving cell without receiving an indication of linkages between the one or more beams received from the first serving cell and the one or more candidate beams associated with the second serving cell.
Aspect 7: The method of any of Aspects 1-6, wherein the indication of the one or more candidate beams associated with the second serving cell indicates multiple candidate beams associated with the second serving cell, and wherein transmitting the RACH uplink communication based at least in part on the indication of the one or more candidate beams associated with the second serving cell comprises: transmitting the RACH uplink communication to the second serving cell using a selected beam of the multiple candidate beams associated with the second serving cell.
Aspect 8: The method of Aspect 7, wherein the indication of the one or more candidate beams includes an indication of multiple candidate downlink reference signal resources associated with the second serving cell, wherein each candidate downlink reference signal resource of the multiple candidate downlink reference signal resources corresponds to a respective candidate beam of the multiple candidate beams, and wherein transmitting the RACH uplink communication to the second serving cell using the selected beam comprises: transmitting the RACH uplink communication to the second serving cell based at least in part on a selected candidate downlink reference signal resource of the multiple candidate downlink reference signal resources.
Aspect 9: The method of Aspect 8, further comprising: selecting the selected candidate downlink reference signal resource based at least in part on measurements of the multiple candidate downlink reference signal resources.
Aspect 10: The method of any of Aspects 8-9, wherein receiving the indication of the one or more candidate beams associated with the second serving cell comprises: receiving the indication of the multiple candidate downlink reference signal resources and an indication of a priority order associated with the multiple candidate downlink reference signal resources, wherein the selected candidate downlink reference signal resource is based at least in part on the priority order associated with the multiple candidate downlink reference signal resources.
Aspect 11: The method of any of Aspects 8-10, wherein receiving the indication of the one or more candidate beams associated with the second serving cell comprises: receiving the indication of the multiple candidate downlink reference signal resources and an indication of predicted mean reference signal received power (RSRP) values for the multiple candidate downlink reference signal resources, wherein the selected candidate downlink reference signal resource is based at least in part on the mean predicted RSRP values for the multiple candidate downlink reference signal resources.
Aspect 12: The method of any of Aspects 8-11, wherein receiving the indication of the one or more candidate beams associated with the second serving cell comprises: receiving the indication of the multiple candidate downlink reference signal resources, an indication of predicted mean reference signal received power (RSRP) values for the multiple candidate downlink reference signal resources, and an indication of prediction confidence levels for the predicted mean RSRP values, wherein the selected candidate downlink reference signal resource is based at least in part on the predicted mean RSRP values for the multiple downlink candidate reference signal resources and the prediction confidence levels for the predicted mean RSRP values.
Aspect 13: The method of any of Aspects 8-12, wherein the multiple candidate downlink reference signal resources associated with the second serving cell include multiple candidate synchronization signal block (SSB) resources associated with the second serving cell, and wherein receiving the indication of the one or more candidate beams associated with the second serving cell comprises: receiving an indication of the multiple candidate SSB resources associated with the second serving cell and an indication of one or more channel state information reference signal (CSI-RS) resources or ports associated with the first serving cell, wherein the selected candidate downlink reference signal resource is a selected candidate SSB resource based at least in part on the multiple candidate SSB resources associated with the second serving cell and the one or more CSI-RS resources or ports associated with the first serving cell.
Aspect 14: The method of Aspect 13, further comprising: selecting the selected candidate SSB resource based at least in part on the multiple candidate SSB resources associated with the second serving cell and the one or more CSI-RS resources or ports associated with the first serving cell using a machine learning model.
Aspect 15: The method of any of Aspects 1-6, wherein the indication of the one or more candidate beams associated with the second serving cell indicates a single beam associated with the second serving cell, and wherein transmitting the RACH uplink communication based at least in part on the indication of the one or more candidate beams associated with the second serving cell comprises: transmitting the RACH uplink communication to the second serving cell using the single beam associated with the second serving cell.
Aspect 16: The method of Aspect 15, wherein the indication of the one or more candidate beams includes an indication of a downlink reference signal resource associated with the second serving cell, wherein the downlink reference signal resource corresponds to the single beam, and wherein transmitting the RACH uplink communication to the second serving cell using the single beam comprises: transmitting the RACH uplink communication to the second serving cell based at least in part on the downlink reference signal resource.
Aspect 17: A method of wireless communication performed by an apparatus of a network node associated with a first serving cell, comprising: receiving, from a user equipment (UE), one or more channel measurements for one or more beams associated with the first serving cell; determining, based at least in part on the one or more channel measurements, one or more candidate beams associated with a second serving cell; and transmitting, to the UE, an indication of the one or more candidate beams associated with the second serving cell.
Aspect 18: The method of Aspect 17, wherein determining, based at least in part on the one or more channel measurements, the one or more candidate beams associated with the second serving cell comprises: determining the one or more candidate beams associated with a second serving cell based at least in part on the one or more channel measurements using a machine learning model.
Aspect 19: The method of any of Aspects 17-18, further comprising: transmitting, to the UE, a request to perform the one or more channel measurements on one or more downlink reference signals associated with the one or more beams associated with the first serving cell.
Aspect 20: The method of any of Aspects 17-19, wherein the one or more channel measurements include at least one of a channel impulse response (CIR) measurement or a reference signal received power (RSRP) measurement.
Aspect 21: The method of any of Aspects 17-20, wherein the first serving cell is associated with a first frequency band and the second serving cell is associated with a second frequency band.
Aspect 22: The method of any of Aspects 17-21, wherein the first serving cell is associated with a master cell group (MCG) and the second serving cell is associated with a secondary cell group (SCG).
Aspect 23: The method of any of Aspects 17-22, wherein transmitting the indication of the one or more candidate beams associated with the second serving cell comprises: transmitting, to the UE, the indication of the one or more candidate beams associated with the second serving cell without transmitting an indication of linkages between the one or more beams associated with the first serving cell and the one or more candidate beams associated with the second serving cell.
Aspect 24: The method of any of Aspects 17-23, wherein the indication of the one or more candidate beams associated with the second serving cell indicates multiple candidate beams associated with the second serving cell.
Aspect 25: The method of Aspect 24, wherein the indication of the one or more candidate beams includes an indication of multiple candidate downlink reference signal resources associated with the second serving cell, wherein each candidate downlink reference signal resource of the multiple candidate downlink reference signal resources corresponds to a respective candidate beam of the multiple candidate beams.
Aspect 26: The method of Aspect 25, wherein transmitting the indication of the one or more candidate beams associated with the second serving cell comprises: transmitting the indication of the multiple candidate downlink reference signal resources and an indication of a priority order associated with the multiple candidate downlink reference signal resources.
Aspect 27: The method of any of Aspects 25-26, wherein transmitting the indication of the one or more candidate beams associated with the second serving cell comprises: transmitting the indication of the multiple candidate downlink reference signal resources and an indication of predicted mean reference signal received power (RSRP) values for the multiple candidate downlink reference signal resources.
Aspect 28: The method of any of Aspects 25-27, wherein transmitting the indication of the one or more candidate beams associated with the second serving cell comprises: transmitting the indication of the multiple candidate downlink reference signal resources, an indication of predicted mean reference signal received power (RSRP) values for the multiple candidate downlink reference signal resources, and an indication of prediction confidence levels for the predicted mean RSRP values.
Aspect 29: The method of any of Aspects 25-28, wherein the multiple candidate downlink reference signal resources associated with the second serving cell include multiple candidate synchronization signal block (SSB) resources associated with the second serving cell, and wherein transmitting the indication of the one or more candidate beams associated with the second serving cell comprises: transmitting an indication of the multiple candidate SSB resources associated with the second serving cell and an indication of one or more channel state information reference signal (CSI-RS) resources or ports associated with the first serving cell.
Aspect 30: The method of any of Aspects 17-23, wherein the indication of the one or more candidate beams associated with the second serving cell indicates a single beam associated with the second serving cell.
Aspect 31: The method of Aspect 30, wherein the indication of the one or more candidate beams includes an indication of a downlink reference signal resource associated with the second serving cell, and wherein the downlink reference signal resource corresponds to the single beam associated with the second serving cell.
Aspect 32: An apparatus for wireless communication at a device, comprising a processor; memory coupled with the processor; and instructions stored in the memory and executable by the processor to cause the apparatus to perform the method of one or more of Aspects 1-16.
Aspect 33: A device for wireless communication, comprising a memory and one or more processors coupled to the memory, the one or more processors configured to perform the method of one or more of Aspects 1-16.
Aspect 34: An apparatus for wireless communication, comprising at least one means for performing the method of one or more of Aspects 1-16.
Aspect 35: A non-transitory computer-readable medium storing code for wireless communication, the code comprising instructions executable by a processor to perform the method of one or more of Aspects 1-16.
Aspect 36: A non-transitory computer-readable medium storing a set of instructions for wireless communication, the set of instructions comprising one or more instructions that, when executed by one or more processors of a device, cause the device to perform the method of one or more of Aspects 1-16.
Aspect 37: An apparatus for wireless communication at a device, comprising a processor; memory coupled with the processor; and instructions stored in the memory and executable by the processor to cause the apparatus to perform the method of one or more of Aspects 17-31.
Aspect 38: A device for wireless communication, comprising a memory and one or more processors coupled to the memory, the one or more processors configured to perform the method of one or more of Aspects 17-31.
Aspect 39: An apparatus for wireless communication, comprising at least one means for performing the method of one or more of Aspects 17-31.
Aspect 40: A non-transitory computer-readable medium storing code for wireless communication, the code comprising instructions executable by a processor to perform the method of one or more of Aspects 17-31.
Aspect 41: A non-transitory computer-readable medium storing a set of instructions for wireless communication, the set of instructions comprising one or more instructions that, when executed by one or more processors of a device, cause the device to perform the method of one or more of Aspects 17-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE), comprising:
one or more memories; and
one or more processors, coupled to the one or more memories, configured to:
transmit, to a first serving cell, one or more channel measurements associated with one or more beams received from the first serving cell;
receive, from the first serving cell, an indication of one or more candidate beams associated with a second serving cell based at least in part on the one or more channel measurements associated with the one or more beams received from the first serving cell; and
transmit, to the second serving cell, a random access channel (RACH) uplink communication based at least in part on the indication of the one or more candidate beams associated with the second serving cell.

2. The UE of claim 1, wherein the one or more processors are further configured to:
receive, from the first serving cell, a request to perform the one or more channel measurements on one or more downlink reference signals associated with the one or more beams received from the first serving cell, wherein the one or more processors, to transmit the one or more channel measurements, are configured to transmit the one or more channel measurements to the first serving cell based at least in part on receiving the request to perform the one or more channel measurements.

3. The UE of claim 1, wherein the one or more channel measurements include at least one of a channel impulse response (CIR) measurement or a reference signal received power (RSRP) measurement.

4. The UE of claim 1, wherein the first serving cell is associated with a first frequency band and the second serving cell is associated with a second frequency band.

5. The UE of claim 1, wherein the first serving cell is associated with a master cell group (MCG) and the second serving cell is associated with a secondary cell group (SCG).

6. The UE of claim 1, wherein the one or more processors, to receive the indication of the one or more candidate beams associated with the second serving cell, are configured to:
receive, from the first serving cell, the indication of the one or more candidate beams associated with the second serving cell without receiving an indication of linkages between the one or more beams received from the first serving cell and the one or more candidate beams associated with the second serving cell.

7. The UE of claim 1, wherein the indication of the one or more candidate beams associated with the second serving cell indicates multiple candidate beams associated with the second serving cell, and wherein the one or more processors, to transmit the RACH uplink communication based at least in part on the indication of the one or more candidate beams associated with the second serving cell, are configured to:
transmit the RACH uplink communication to the second serving cell using a selected beam of the multiple candidate beams associated with the second serving cell.

8. The UE of claim 7, wherein the indication of the one or more candidate beams includes an indication of multiple candidate downlink reference signal resources associated with the second serving cell, wherein each candidate downlink reference signal resource of the multiple candidate downlink reference signal resources corresponds to a respective candidate beam of the multiple candidate beams, and wherein the one or more processors, to transmit the RACH uplink communication to the second serving cell using the selected beam, are configured to:
transmit the RACH uplink communication to the second serving cell based at least in part on a selected candidate downlink reference signal resource of the multiple candidate downlink reference signal resources.

9. The UE of claim 8, wherein the one or more processors are further configured to:
select the selected candidate downlink reference signal resource based at least in part on measurements of the multiple candidate downlink reference signal resources.

10. The UE of claim 8, wherein the one or more processors, to receive the indication of the one or more candidate beams associated with the second serving cell, are configured to:
receive the indication of the multiple candidate downlink reference signal resources and an indication of a priority order associated with the multiple candidate downlink reference signal resources, wherein the selected candidate downlink reference signal resource is based at least in part on the priority order associated with the multiple candidate downlink reference signal resources.

11. The UE of claim 8, wherein the one or more processors, to receive the indication of the one or more candidate beams associated with the second serving cell, are configured to:
receive the indication of the multiple candidate downlink reference signal resources and an indication of predicted mean reference signal received power (RSRP) values for the multiple candidate downlink reference signal resources, wherein the selected candidate downlink reference signal resource is based at least in part on the mean predicted RSRP values for the multiple candidate downlink reference signal resources.

12. The UE of claim 8, wherein the one or more processors, to receive the indication of the one or more candidate beams associated with the second serving cell, are configured to:
receive the indication of the multiple candidate downlink reference signal resources, an indication of predicted mean reference signal received power (RSRP) values for the multiple candidate downlink reference signal resources, and an indication of prediction confidence levels for the predicted mean RSRP values, wherein the selected candidate downlink reference signal resource is based at least in part on the predicted mean RSRP values for the multiple downlink candidate reference signal resources and the prediction confidence levels for the predicted mean RSRP values.

13. The UE of claim 8, wherein the multiple candidate downlink reference signal resources associated with the second serving cell include multiple candidate synchronization signal block (SSB) resources associated with the second serving cell, and wherein the one or more processors, to receive the indication of the one or more candidate beams associated with the second serving cell, are configured to:
receive an indication of the multiple candidate SSB resources associated with the second serving cell and an indication of one or more channel state information reference signal (CSI-RS) resources or ports associated with the first serving cell, wherein the selected candidate downlink reference signal resource is a selected candidate SSB resource based at least in part on the multiple candidate SSB resources associated with the second serving cell and the one or more CSI-RS resources or ports associated with the first serving cell.

14. The UE of claim 13, wherein the one or more processors are further configured to:
select the selected candidate SSB resource based at least in part on the multiple candidate SSB resources associated with the second serving cell and the one or more CSI-RS resources or ports associated with the first serving cell using a machine learning model.

15. The UE of claim 1, wherein the indication of the one or more candidate beams associated with the second serving cell indicates a single beam associated with the second serving cell, and wherein the one or more processors, to transmit the RACH uplink communication based at least in part on the indication of the one or more candidate beams associated with the second serving cell, are configured to:
transmit the RACH uplink communication to the second serving cell using the single beam associated with the second serving cell.

16. The UE of claim 15, wherein the indication of the one or more candidate beams includes an indication of a downlink reference signal resource associated with the second serving cell, wherein the downlink reference signal resource corresponds to the single beam, and wherein the one or more processors, to transmit the RACH uplink communication to the second serving cell using the single beam, are configured to:
transmit the RACH uplink communication to the second serving cell based at least in part on the downlink reference signal resource.

17. A network node associated with a first serving cell, comprising:
one or more memories; and
one or more processors, coupled to the one or more memories, configured to:
receive, from a user equipment (UE), one or more channel measurements for one or more beams associated with the first serving cell;
determine, based at least in part on the one or more channel measurements, one or more candidate beams associated with a second serving cell; and
transmit, to the UE, an indication of the one or more candidate beams associated with the second serving cell.

18. The network node of claim 17, wherein the one or more processors, to determine, based at least in part on the one or more channel measurements, the one or more candidate beams associated with the second serving cell, are configured to:
determine the one or more candidate beams associated with a second serving cell based at least in part on the one or more channel measurements using a machine learning model.

19. The network node of claim 17, wherein the indication of the one or more candidate beams associated with the second serving cell indicates multiple candidate beams associated with the second serving cell.

20-23. (canceled)

24. A method of wireless communication performed by an apparatus of a user equipment (UE), comprising:
transmitting, to a first serving cell, one or more channel measurements associated with one or more beams received from the first serving cell;
receiving, from the first serving cell, an indication of one or more candidate beams associated with a second serving cell based at least in part on the one or more channel measurements associated with the one or more beams received from the first serving cell; and
transmitting, to the second serving cell, a random access channel (RACH) uplink communication based at least in part on the indication of the one or more candidate beams associated with the second serving cell.

25-30. (canceled)
